(19) United States
(12) Patent Application Publication
(10) Pub. No.: US 2024/0356143 A1
(43) Pub. Date: Oct. 24, 2024

(54) BATTERY ADAPTER AND BATTERY SYSTEM FOR HELMET MOUNT ASSEMBLY

(71) Applicant: WILCOX INDUSTRIES CORP., Newington, NH (US)

(72) Inventors: James W. Teetzel, Portsmouth, NH (US); Elliott S. Turner, Newmarket, NH (US)

(21) Appl. No.: 18/636,599

(22) Filed: Apr. 16, 2024

Related U.S. Application Data
(60) Provisional application No. 63/461,538, filed on Apr. 24, 2023.

(51) Int. Cl. H01M 50/264; H01M 50/247; H02J 7/00

(52) U.S. Cl. CPC H01M 50/264; H01M 50/247; H02J 7/0045; H01M 2220/30

(57) ABSTRACT

In one aspect, a battery pack adapter comprises a first side configured for coupling to a helmet accessory control unit and a second side opposite the first side configured for detachably coupling to a battery pack. The first side comprises first and second protruding attachment lugs configured to be detachably received within first and second complementary receptacles, respectively, on the helmet accessory control unit. Each of the first and second protruding attachment lugs comprises a magnetic fastener element configured to magnetically engage with an aligned magnetic fastener element in a respective one of the complementary receptacles. Each of the first and second protruding attachment lugs comprise electrical connector elements configured to establish an electrical connection with aligned electrical contacts in a respective one of the complementary receptacles. In further aspects, battery pack system comprising the battery pack adapter are provided.

### RELATED APPLICATION

This application claims the priority benefit of U.S. provisional application No. 63/461,538 filed Apr. 24, 2023. The aforementioned application is incorporated herein by reference in its entirety.

### INCORPORATION BY REFERENCE

This application is related to U.S. provisional application Ser. No. 63/433,661 filed Dec. 19, 2022; U.S. nonprovisional application Ser. No. 18/544,128 filed Dec. 18, 2023; U.S. provisional application Ser. No. 63/454,691 filed Mar. 26, 2023, and U.S. nonprovisional application Ser. No. 18/614,070 filed Mar. 22, 2024. Each of the aforementioned applications is incorporated herein by reference in its entirety.

### BACKGROUND

The present disclosure relates to batteries and, in particular, to a battery attachment system for a powered helmet mount assembly.

### SUMMARY

In one aspect, a battery pack system for a helmet mount assembly includes a center base module configured for electrical and physical attachment to a helmet mount assembly. First and second battery packs are configured for removable attachment to the center base module. Each of the first and second battery packs have a pair of protruding attachment lugs, wherein each of the attachment lugs has first magnetic fastener element and a first electrical connector element. The center base module has a first side surface configured for detachably securing the first battery pack. The center base module has a second side surface opposite the first side surface configured for detachably securing the second battery pack. Each of the first and second side surfaces include a pair of lug receptacles for receiving a respective one of the pairs of protruding attachment lugs. Each lug receptacle has a second magnetic fastener element for physically coupling to a respective one of the first magnetic fastener elements. Each lug receptacle has a second electrical connector element for electrically coupling to a respective one of the first electrical connector elements.

In embodiments, the center base module includes a selector switch that allows switching between the left and right battery packs without interruption to the power being supplied to the helmet mount assembly, which allows rapidly switching of the power supply when one of the battery packs is depleted and avoids the need to shut down, reboot, or otherwise power cycle an attached accessory device receiving power over the helmet mount assembly.

The magnetic fastener elements also allow a depleted battery pack to be pulled away from the center base module by manually pulling the battery pack with a force greater than the magnetic force of attraction between the magnetic fastener elements, which allows the user to easily change the batteries with the battery pack in front of the body and in plain view of the user, which task would otherwise be difficult to do blindly reaching behind the back of the helmet.

In a further aspect, a battery pack system for a helmet mount assembly includes a center base module configured for electrical and physical attachment to a helmet mount assembly. First and second battery packs are configured for removable attachment to the center base module. A first adapter is hingedly attached to a first side of the center base module and has a first interface surface configured for removable attachment to the first battery pack. A second adapter is hingedly attached to a second side of the center base module and has a second interface surface configured for removable attachment to the second battery pack.

In a further aspect, a battery pack adapter includes a first side configured for coupling to a helmet accessory control unit and a second side opposite the first side configured for detachably coupling to a battery pack. The first side includes first and second protruding attachment lugs configured to be detachably received within first and second complementary receptacles, respectively, on the helmet accessory control unit. Each of the first and second protruding attachment lugs include a magnetic fastener element configured to magnetically engage with an aligned magnetic fastener element in a respective one of the complementary receptacles. Each of the first and second protruding attachment lugs include electrical connector elements configured to establish an electrical connection with aligned electrical contacts in a respective one of the complementary receptacles.

In a more limited aspect, each of the first and second protruding attachment lugs include a slot configured to removably receive a locking plate when the battery pack adapter is attached to the helmet accessory control unit.

In another more limited aspect, the second side is configured for detachable coupling to a battery pack which conforms to a Small Tactical Universal Battery (STUB) standard for battery pack interfaces.

In another more limited aspect, a battery pack system for a helmet mount assembly includes at least one battery pack adapter and the helmet accessory control unit.

In another more limited aspect, the helmet mount assembly is a center base module configured for electrical and physical attachment to a helmet mount assembly. The battery pack system further includes a first battery pack and the at least one battery pack adapter includes a first battery pack adapter configured to be detachably coupled to a first side of the center base module wherein the first and second protruding lugs are configured for removable attachment to aligned and facing first and second sockets on the first side of the center base module.

In another more limited aspect, the battery pack system further includes a first lock bar on the center base module which is movable between a locking position and an unlocking position. The first lock bar includes a first latching plate engaging complementary grooves in the first and second protruding lugs on the first battery pack when the first adapter is attached to the center base module.

In another more limited aspect, the battery pack system further includes a second battery pack and the at least one battery pack adapter includes a second battery pack adapter configured to be detachably coupled to a second side of the center base module wherein the first and second protruding lugs are configured for removable attachment to aligned and facing first and second sockets on the second side of the center base module.

In another more limited aspect, the battery pack system further includes a second lock bar on the center base module movable between a locking position and an unlocking position. The second lock bar includes a second latching plate engaging complementary grooves in the first and second protruding lugs on the second battery pack when the second adapter is attached to center base module.

In further aspect, a battery pack system for a helmet mount assembly includes a center base module configured for electrical and physical attachment to the helmet mount assembly. First and second battery packs are removably attachable to the center base module. Each of the first and second battery packs have a pair of protruding attachment lugs, and each of the attachment lugs have first magnetic fastener element and a first electrical connector element. The center base module has a first side surface configured for detachably securing the first battery pack and a second side surface opposite the first side surface configured for detachably securing the second battery pack. Each of the first and second side surfaces include a pair of lug receptacles for receiving a respective one of the pairs of protruding attachment lugs. Each lug receptacle has a second magnetic fastener element for physically coupling to a respective one of the first magnetic fastener elements. Each lug receptacle has a second electrical connector element for electrically coupling to a respective one of the first electrical connector elements.

In another more limited aspect, the battery pack system further includes an adapter interchangeably attachable to the helmet mount assembly in place of the center base module and configured to releasably attach a third battery pack.

In another more limited aspect, the center base module includes a modular processing system removably received within a main body of the center base module.

In another more limited aspect, the center base module includes a switch configured to selectively couple a selected one of the first and second battery packs, wherein each of the first and second battery packs is replaceable independently of the other.

In another more limited aspect, the battery pack system further includes first and second adapters, the first adapter having a first interface surface configured for removable attachment to the first side surface of the center base module and a second interface surface configured for removable attachment to the first battery pack. The second adapter has a third interface surface configured for removable attachment to the second side surface of the center base module and a fourth interface surface configured for removable attachment to the second battery pack.

In another more limited aspect, the first and second battery packs are STUB battery packs.

In another aspect, a battery pack system for a helmet mount assembly includes a center base module configured for electrical and physical attachment to a helmet mount assembly. First and second battery packs are removably attachable to the center base module. A first adapter is hingedly attached to a first side of the center base module and has a first interface surface configured for removable attachment to the first battery pack. A second adapter is hingedly attached to a second side of the center base module and has a second interface surface configured for removable attachment to the second battery pack.

In more limited aspect, the first and second adapters are pivotable between a deployed position wherein the first and second battery packs are pivoted toward the helmet and a non-deployed position wherein the first and second battery packs are pivoted away the helmet to facilitate attachment and removal of the first and second battery packs.

In another more limited aspect, the first and second battery packs are STUB battery packs.

### BRIEF DESCRIPTION OF THE DRAWINGS

The invention may take form in various components and arrangements of components, and in various steps and arrangements of steps. The drawings are only for purposes of illustrating preferred embodiments and are not to be construed as limiting the invention.

FIG. 1 is an isometric view of an exemplary embodiment powered helmet mounting assembly attached to a helmet taken generally from the rear and left side, the powered helmet mounting assembly having a first embodiment battery pack center base module attached to a rear mount assembly of the powered helmet mounting assembly.

FIG. 2 is a top plan view of the helmet with the powered helmet mounting assembly and battery pack center base module appearing in FIG. 1,

FIG. 3 is an enlarged, top plan view of the battery pack center base module appearing in FIG. 1.

FIG. 4 is an enlarged, rear elevational view of the battery pack center base module appearing in FIG. 3.

FIG. 5 is an isometric view, taken generally from the rear and left side, of the exemplary embodiment powered helmet mounting assembly, helmet, and battery pack center base module appearing in FIG. 1, showing the battery pack center base module shown detached from the rear mount assembly of the powered helmet mounting assembly and further showing the manner in which the battery pack center base module can be replaced with a battery pack adapter to allow other battery packs, such as legacy battery packs, to be operably coupled to the helmet mounting system.

FIG. 6 is an isometric view of the powered helmet mounting assembly, helmet, and battery pack center base module appearing in FIG. 1, wherein left and right battery packs as removably attached to the battery pack center base module.

FIG. 7 is a top plan view of the powered helmet mounting assembly, helmet, battery pack center base module, and left and right battery packs appearing in FIG. 6.

FIG. 8 is a top plan view of the battery pack center base module with left and right battery packs appearing in FIG. 6.

FIG. 9 is a rear elevational view of the battery pack center base module with left and right battery packs appearing in FIG. 6.

FIG. 10 is a front elevational view of the battery pack center base module with left and right battery packs appearing in FIG. 6.

FIG. 11 is a fragmentary top view of the helmet with powered helmet mounting assembly, with the battery pack center base module of FIG. 1 attached to the rear mount assembly on the powered helmet mounting assembly.

FIG. 12 is an exploded top plan view of the battery pack center base module with left and right battery packs appearing in FIG. 8.

FIG. 13 is an enlarged isometric view of showing the manner of attachment of a battery pack to battery pack center base module.

FIG. 14 is an enlarged elevational view of the battery pack center base module showing the left side battery pack connector interface.

FIG. 15 is an enlarged end elevational view of a battery pack, taken from the connection interface end.

FIG. 16 an enlarged elevational view of the battery pack appearing in FIG. 15, taken generally from the side.

FIG. 17 an elevational view of a battery pack attached to the right side of the battery pack center base module, with a cutaway region showing the electrical and physical connections.

FIGS. 18 and 19 illustrate the battery pack center base module with an alternative battery pack and show the manner of attaching the battery pack to the battery pack center base module.

FIG. 20 illustrates the battery pack center base module with another alternative battery pack.

FIG. 21 illustrates the battery pack center base module with yet another alternative battery pack.

FIG. 22 is an isometric view of the battery pack center base module with left and right battery packs attached and showing the hinged rear panel in the open position for receiving a modular processing board cartridge.

FIG. 23 is an enlarged rear elevational view of the modular processing board cartridge appearing in FIG. 22.

FIG. 24 is an enlarged bottom plan view of the modular processing board cartridge appearing in FIG. 23.

FIG. 25 is an isometric view of the battery pack center base module with left and right battery packs attached and showing the hinged bottom panel in the open position for receiving programmable electronic storage media, such as non-volatile flash memory cards.

FIG. 26 is an isometric view of a further exemplary embodiment powered helmet mounting assembly attached to a helmet taken generally from the rear and left side, the powered helmet mounting assembly having the first embodiment battery pack center base module attached to a rear mount assembly of the powered helmet mounting assembly, the battery pack center base module further including left and right battery pack adapters for removably attaching battery packs in accordance with the Small Tactical Universal Battery (STUB) standard (e.g., Department of Defense MIL-PRF-32383).

FIG. 27 is a rear elevational view of the battery pack center base module and two attached STUB battery packs.

FIG. 28 is a partially exploded view of the battery pack center base module and STUB battery packs appearing in FIG. 27.

FIG. 29A is a fragmentary isometric view of an exemplary STUB battery pack usable with the present development.

FIG. 29B is a top view of an exemplary STUB battery pack useable with the present development.

FIG. 30 is a side elevational view of the STUB battery pack adapter.

FIG. 31 is a first end elevational view of the STUB battery pack adapter illustrating the connection interface for attaching the STUB battery pack.

FIG. 32 is a second end elevational view of the STUB battery pack adapter illustrating the connection interface for attaching the STUB battery pack adapter to the battery pack center base module.

FIG. 33 illustrates a second embodiment battery pack center base module with a hinged interface configured for removably attaching STUB battery packs.

FIG. 34 is a top plan view of the battery pack center base module with left and right attached STUB battery packs, showing the range of pivoting hinge movement allowing the STUB battery packs to be pivoted in relation to the battery pack center base module toward and away from the helmet.

FIG. 35 is an isometric view of the battery pack center base module with left and right STUB battery packs, illustrating the manner of attaching and detaching the STUB battery packs.

FIG. 36 is an elevational view of the hinged connector on the battery pack center base module, illustrating the connection interface of the hinged connector.

FIG. 37 is a top view of a battery pack center base module with left and right battery packs, in accordance with a third embodiment.

FIG. 38 is a front view of the battery pack center base module with left and right battery packs appearing in FIG. 37.

FIG. 39 is a rear view of the battery pack center base module with left and right battery packs appearing in FIG. 37.

FIG. 40 is a fragmentary top view of the helmet with powered helmet mounting assembly, with the battery pack center base module of FIG. 37 attached to the rear mount assembly on the powered helmet mounting assembly.

FIG. 41 illustrates two alternative methods of programming a modular processing board cartridge within the battery pack center base module.

FIG. 42 is a rear view of a battery pack center base module with left and right battery packs, in accordance with a fourth embodiment.

FIG. 43 is a top view of the battery pack center base module with left and right battery packs appearing in FIG. 42.

FIG. 44 is a bottom view of the battery pack center base module with left and right battery packs appearing in FIG. 42.

FIG. 45 is a side view of the battery pack center base module with left and right battery packs appearing in FIG. 42.

FIG. 46 is a front view of the battery pack center base module with left and right battery packs appearing in FIG. 42.

FIG. 47 is an isometric view of a battery pack center base module appearing in FIG. 42, showing interchangeability of multiple cartridge styles.

FIG. 48 is a front view of a first interchangeable cartridge embodiment.

FIG. 49 is a bottom view of the cartridge embodiment appearing in FIG. 48.

FIG. 50 is a side view of the cartridge embodiment appearing in FIG. 48.

FIG. 51 is a front view of a second interchangeable cartridge embodiment.

FIG. 52 is a bottom view of the cartridge embodiment appearing in FIG. 53.

FIG. 53 as a partially exploded view of a further embodiment battery system comprising a magnetic, locking center base module with STUB battery pack adapters.

FIG. 54 is a side view of the center base module appearing in FIG. 53, with the center base module shown in partial cut away.

FIG. 55 is a generally rear view of the center base module appearing in FIG. 53.

FIG. 56 is a side view of the STUB battery adapter appearing in FIG. 53.

FIG. 57 is a top view of the center base module appearing in FIG. 53.

FIG. 58 is a generally rear view of the center base module appearing in FIG. 53 with the center base module and STUB adapter shown in partial cut away.

### DETAILED DESCRIPTION OF THE PREFERRED EMBODIMENTS

Reference will now be made in detail to presently preferred embodiments of the invention, one or more examples of which are illustrated in the accompanying drawings. Each example is provided by way of explanation of the invention, not limitation of the invention, which may be embodied in various forms. Therefore, specific structural and functional details disclosed herein are not to be interpreted as limiting but merely as a basis for the claims and as a representative basis for teaching one skilled in the art to variously employ the present inventive concept in virtually any appropriately detailed structure. Further, the terms and phrases used herein are not intended to be limiting but rather to provide an understandable description of the present development. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

The terms “a” or “an,” as used herein, are defined as one or more than one. The term “another,” as used herein, is defined as at least a second or more. The terms “including” and/or “having” as used herein, are defined as comprising (i.e., open transition). The term “coupled” or “operatively coupled,” as used herein, is defined as indirectly or directly connected.

As used in this application, the terms “front,” “rear,” “upper,” “lower,” “upwardly,” “downwardly,” “left,” “right,” and other orientation descriptors are intended to facilitate the description of the exemplary embodiment(s) of the present invention, and are not intended to limit the structure thereof to any particular position or orientation.

All numbers herein are assumed to be modified by the term “about,” unless stated otherwise. The recitation of numerical ranges by endpoints includes all numbers subsumed within that range (e.g., 1 to 5 includes 1, 1.5, 2, 2.75, 3, 3.80, 4, and 5).

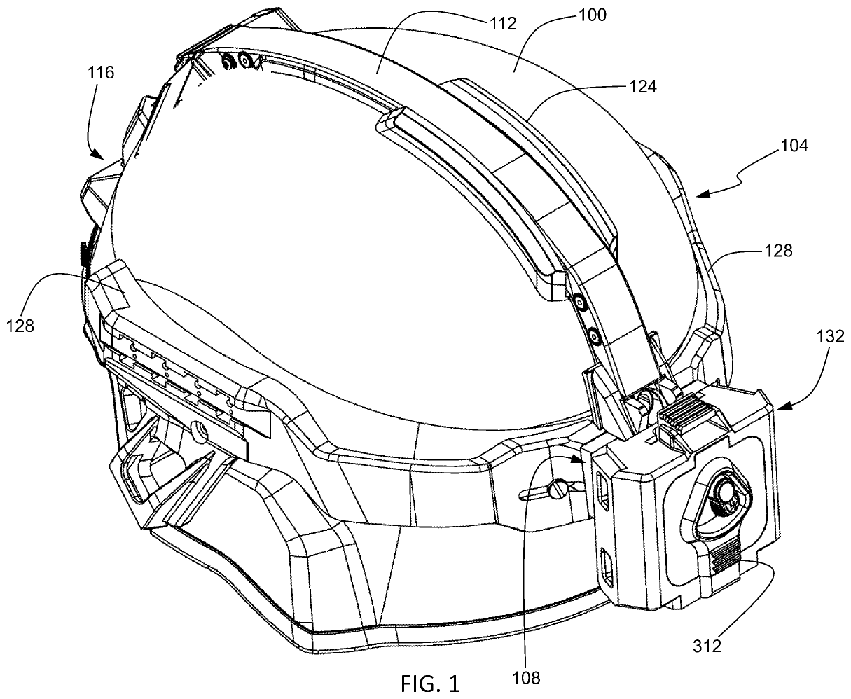

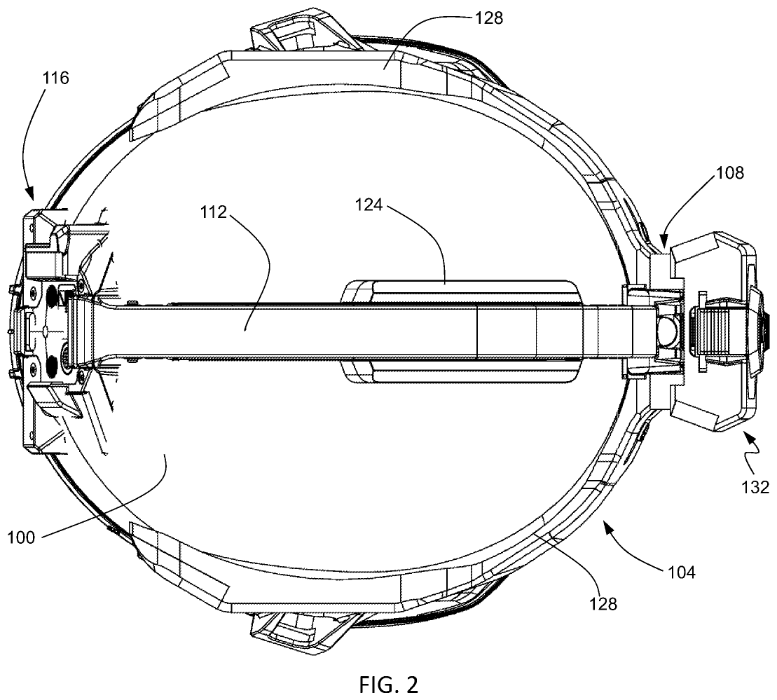

Referring now to FIGS. 1 and 2, there is shown a helmet 100 having a helmet mount assembly designated generally as reference numeral 104. In embodiments, the helmet mount assembly may be as shown and described in commonly owned U.S. provisional patent application Ser. No. 63/427,496 filed Nov. 23, 2022, the entire contents of which are incorporated herein by reference in its entirety. In the illustrated embodiment, the helmet 100 is an Integrated Head Protection System (IHPS) helmet, it will be recognized that the present development can be adapted for use with all manner of protective helmets, including a Modular Integrated Communications Helmet (MICH), Advanced Combat Helmet (ACH), Enhanced Combat Helmet (ECH), and so forth.

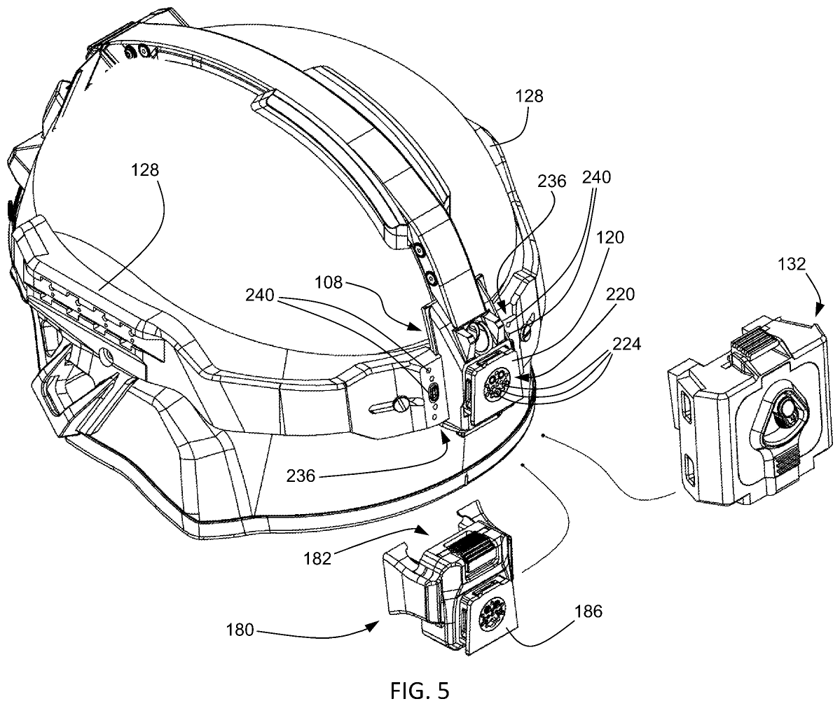

In the illustrated embodiment, the helmet mount assembly 104 includes a rear battery mounting bracket 108 disposed at the rear of the helmet 100. A strap or cable cover 112 extends along a centerline of the helmet 100 from the rear battery mounting bracket 108 to a front shroud 116 disposed at the front of the helmet 100. The battery mounting bracket 108 includes a hot shoe style interface 120 (see FIG. 5). The front shroud 116, strap or cable cover 112, and rear mounting bracket 108 may be as described in commonly-owned U.S. Pat. No. 10,886,646 or commonly-owned U.S. Pat. No. 11,360,309, each of which is incorporated herein by reference in its entirety. An identification friend or for (IFF) module 124 is retained on the helmet 100 via the strap/cable cover 112. Left and right shrouds 128 are attached to the respective left and right sides of the helmet 100 via a threaded fastener 134 engaging a clearance opening 136 in the shrouds 132 and extend between the rear battery mounting bracket 108 and the front shroud 116. A battery pack center base module 132 is releasably attached to the rear battery mounting bracket 108

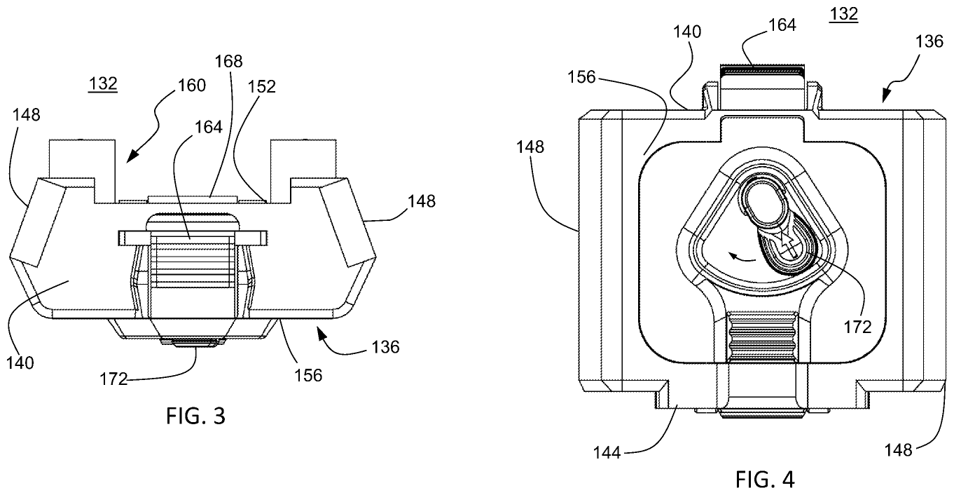

Referring now to FIGS. 3 and 4, and with continued reference to FIGS. 1 and 2, the battery pack center base module 132 includes a main body 136 having a top surface 140, bottom surface 144, left and right side surfaces 148, a front or forward facing surface 152, and a rear or rearward facing surface 156. The front facing surface 152 includes a hot shoe receptacle 160 for detachably receiving the hot shoe mounting interface 120 on the rear battery mounting bracket 108. As best seen in FIG. 5, in the illustrated embodiment, the hot shoe interface 120 includes a dovetail mounting member and the hot shoe receptacle 160 includes a complementary dovetail receptacle for sliding engagement. A latch release button 164 is disposed on the upper surface 140 for disengaging a latch member 168 to allow sliding removal of the battery pack center base module 132 from the rear battery mounting bracket 108.

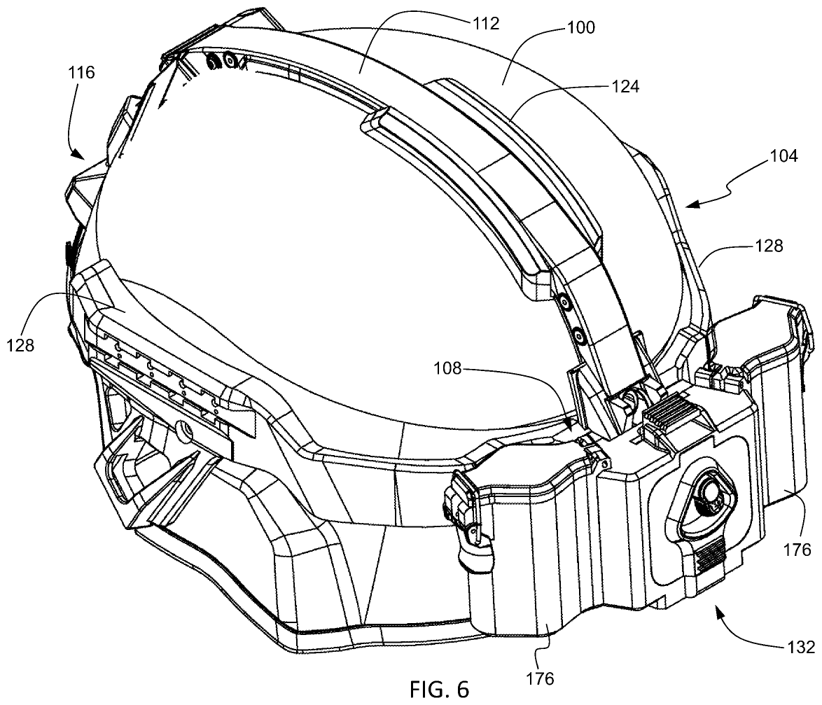

A battery selector switch 172 is pivotable between a left position and a right position. When the selector switch 172 is in the right position, the battery pack center base module 132 electrically couples a battery pack 176 (see FIG. 6) attached to the right side of the battery pack center base module 132 to the helmet mount assembly 104 via the rear battery mounting bracket 108. When the selector switch 172 is moved the left position as indicated by the arrow appearing in FIG. 4, the battery pack center base module 132 electrically couples a battery pack 176 (see FIG. 6) attached to the right side of the battery pack center base module 132 to the helmet mount assembly 104 via the rear battery mounting bracket 108. In operation, the user may use one of the battery packs 176 until it is depleted or nearly depleted and then use the selector switch 172 to switch the electrical connection to the other one of the battery packs 176.

In embodiments, the selector 172 allows switching between the left and right battery packs without interruption to the power being supplied to the helmet mount assembly 104. This is particularly advantageous when an accessory device attached to the helmet mount assembly 104 is a night vision device or other device which requires rebooting, which can sometimes take several minutes to complete, when the power is cycled. Each battery pack 176 is individually swappable such that when one battery pack 176 is depleted it can be changed without affecting operation of the devices being powered. In operation, when one of the battery packs 176 is depleted, the user then moves the selector switch to the battery pack 176 that is fully charged. The depleted battery pack 176 can then be pulled away from the center base module 132, overcoming the force of attraction between the magnetic fastener elements on the center base module and the battery pack, thereby allowing the user to easily change the batteries in front of the body in plain view of the user; whereas, otherwise this task is difficult to do blindly reaching around the back.

Referring now to FIG. 5 and with continued reference to FIGS. 1-4, there is shown a helmet 100 with helmet mount assembly 104 with the rear battery mounting bracket 108 configured to receive the battery pack center base module 132, wherein the helmet mounting system further includes a battery pack adapter 180 configured to interchangeably attach to the rear battery mounting bracket 108 in place of the battery pack center base module 132. The adapter 180 includes a receptacle 182 receiving the hot shoe 120 and a hot shoe 186 configured to attach an existing or legacy battery pack (not shown). The dedicated battery pack center base module 132 is advantageous in that it does not require an adapter and connects directly to the helmet mount assembly 104 and thereby reduces the profile of the attached battery pack in relation to the surface of the helmet. However, the battery pack adapter 180 increases the functionality of the helmet mount assembly 104 in that allows for the use of other types of battery packs, such as preexisting or legacy battery packs, such as Elbit battery packs (e.g., ENVG-B battery box), Harris L3 battery packs, and the like.

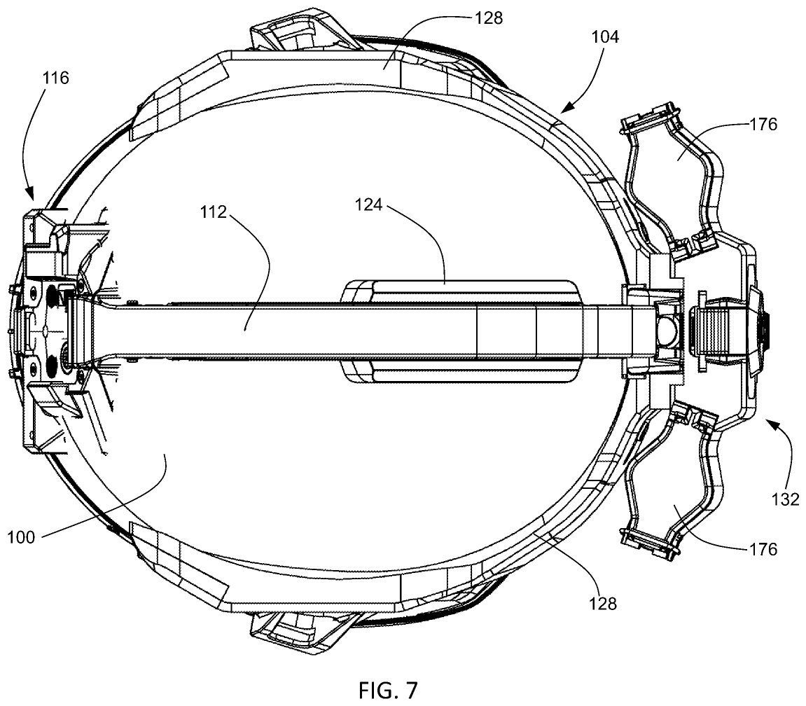

Referring now to FIGS. 6 and 7 and with continued reference to FIGS. 1-5, there is shown a helmet 100 with helmet mount assembly 104 with the rear battery mounting bracket 108 receiving the battery pack center base module 132, as shown in FIGS. 1 and 2, respectively, wherein the battery pack center base module 132 has a battery pack 176 attached to each of the left and right side surfaces 148 thereof.

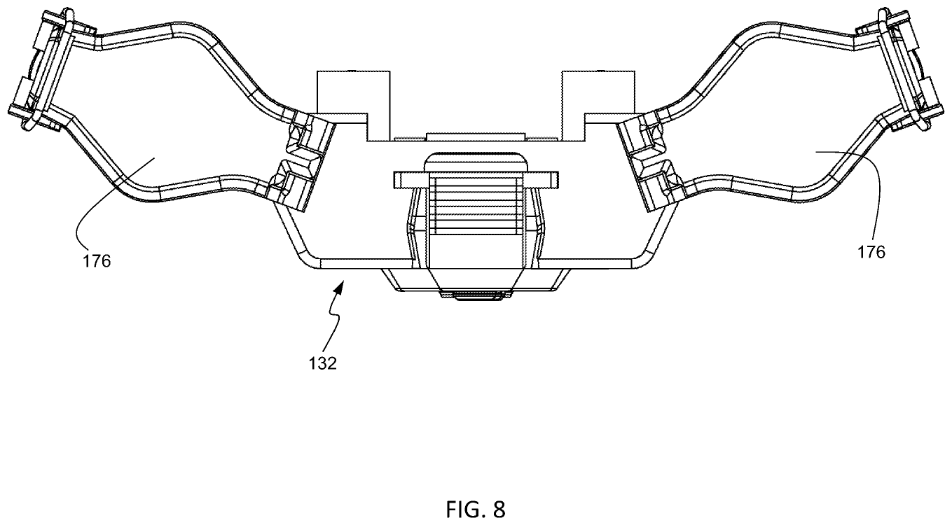

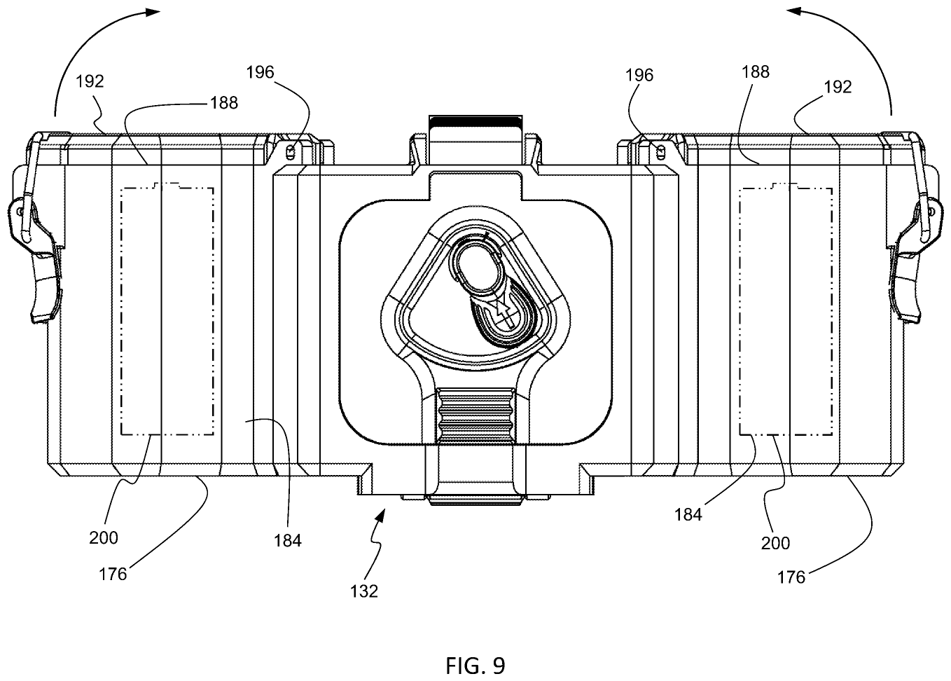

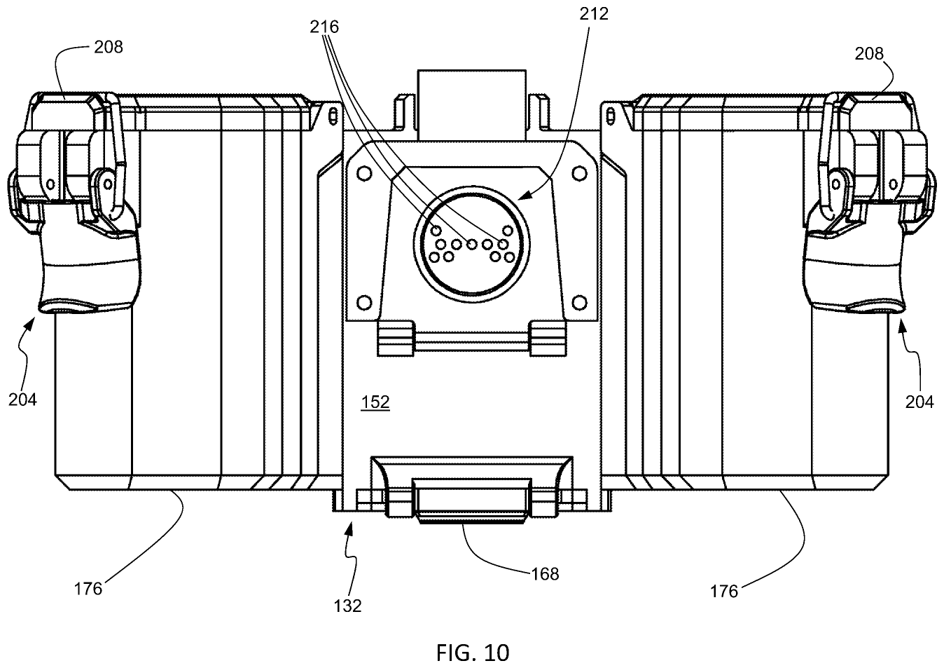

Referring now to FIGS. 8-10 and with continued reference to FIGS. 1-7, there is shown top, rear, and front views, respectively, of the battery pack center base module 132, as shown in FIGS. 3 and 4, respectively, wherein the battery pack center base module 132 has a battery pack 176 attached to each of the left and right side surfaces 148 thereof.

In the illustrated exemplary embodiment, the battery pack 176 includes a housing 184 defining a battery compartment. The housing 184 has an open upper end 188 which is closed by a hinged cover 192. The hinged cover 192 is pivotally attached to the housing 184 via a hinge 196 disposed at the proximal end of the cover 192 to allow opening and closing of the battery pack for insertion and removal of battery (ies) 200 into and from the housing 184. In embodiments, housing 184 includes releasable coupling element 204, secured to the housing 184 adjacent the distal end of the battery pack cover 192, such as a latch (e.g., draw latch), clasp, buckle, or other releasable coupling as would be understood by persons skilled in the art. The coupling element 204 releasably engages a complementary attachment feature, such as a catch 208 disposed on the distal end of the cover 192.

The forward facing surface 152 of the battery pack center base module 132 includes an electrical connector element 212 comprising a plurality of electrical contacts 216. The connector element 212 is aligned with an opposing connector element 220 on the hot shoe interface 120 on the rear battery mounting bracket 108, the connector element 220 comprising a plurality of electrical contacts 224 which are aligned with and face the electrical contacts 216 to provide communication of power, data, and control signals between the battery pack center base module 132 and the helmet mount assembly 104.

The forward facing surface 152 of the battery pack center base module 132 further includes an electrical connector element 212 comprising a plurality of electrical contacts 216. The connector element 212 is aligned with an opposing connector element 220 on the hot shoe interface 120 on the rear battery mounting bracket 108, the connector element 220 comprising a plurality of electrical contacts 224 which are aligned with and face the electrical contacts 216.

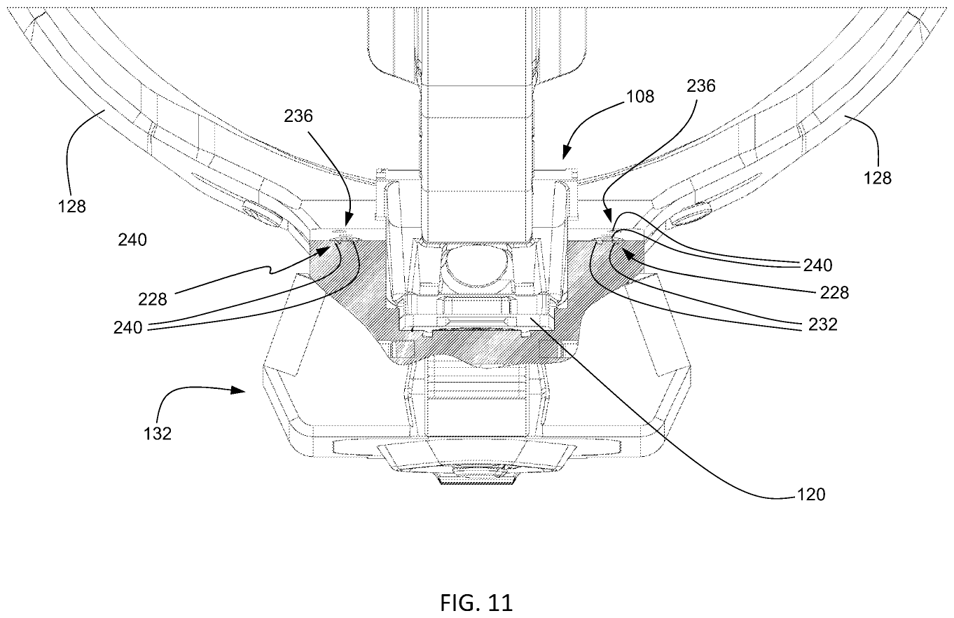

Referring now to FIG. 11, and with continued reference to FIGS. 1-10, there is shown a top view illustrating the battery pack center base module 132 attached to the rear battery mounting bracket 108, wherein a portion of the battery pack center base module 132 is cutaway to show the hot shoe 120 within the hot shoe receptacle 160. The forward facing surface 152 of the battery pack center base module 132 further includes a left and right electrical connector elements 228 comprising a plurality of electrical contacts 232. The connector elements 228 are aligned with opposing left and right connector elements 236 on the left and right helmet brackets 128, respectively. The connector element 236 includes a plurality of electrical contacts 224 which are aligned with and face the electrical contacts 232.

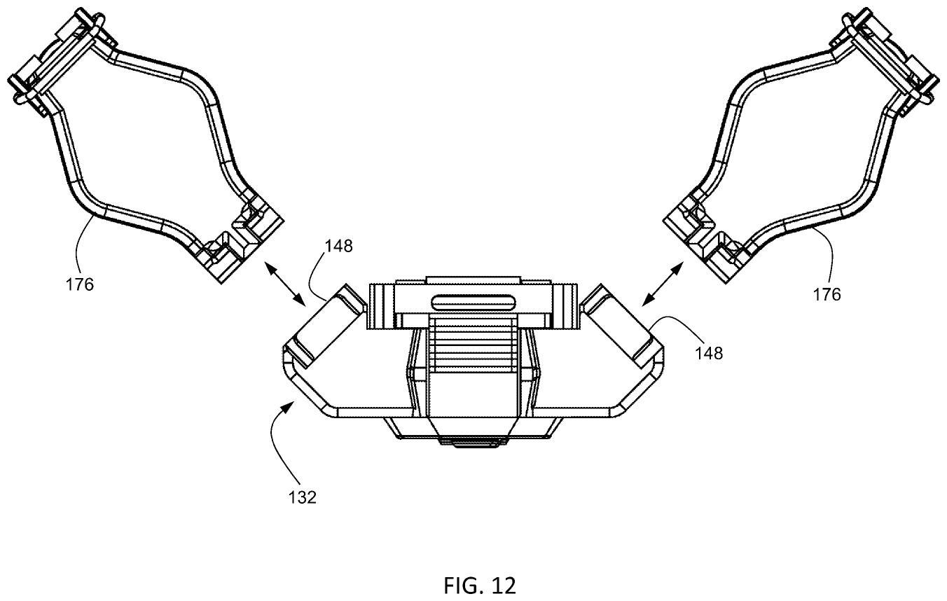

Referring now to FIG. 12, and with continued reference to FIGS. 1-11, there is shown the battery pack center base module 132 with the left and right battery packs 176 spaced apart from the respective left and right side surfaces 148, illustrating the manner of attachment and removal of the battery packs 176 from the battery pack center base module 132.

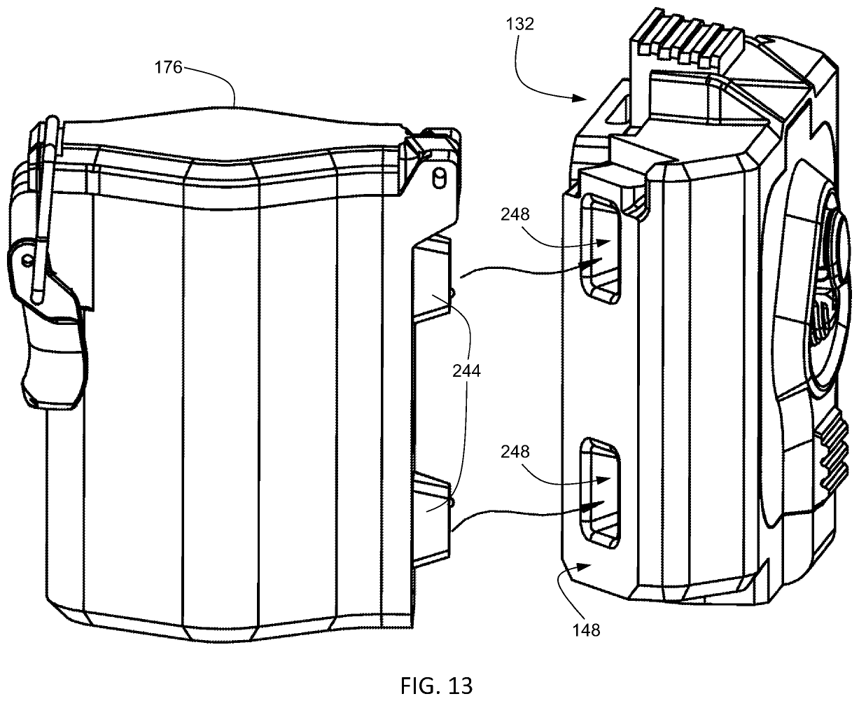

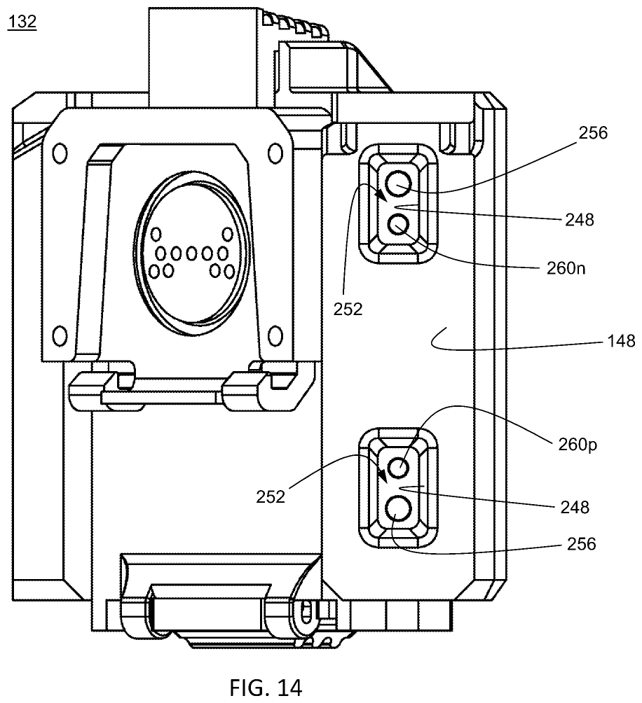

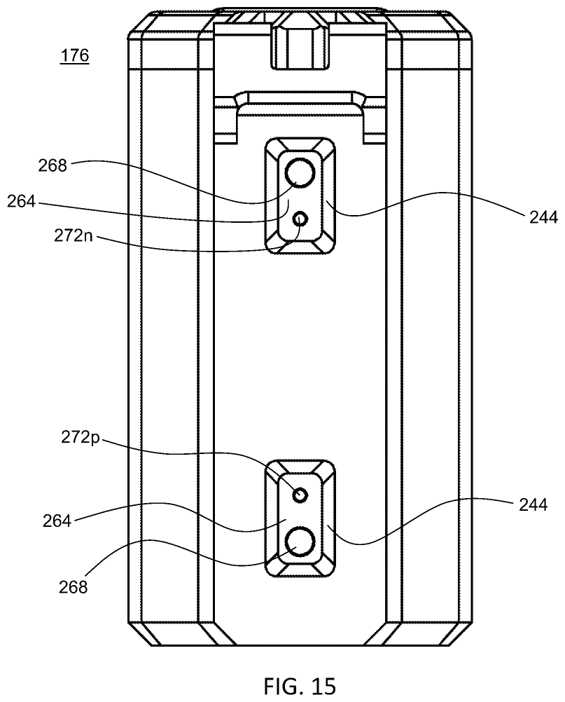

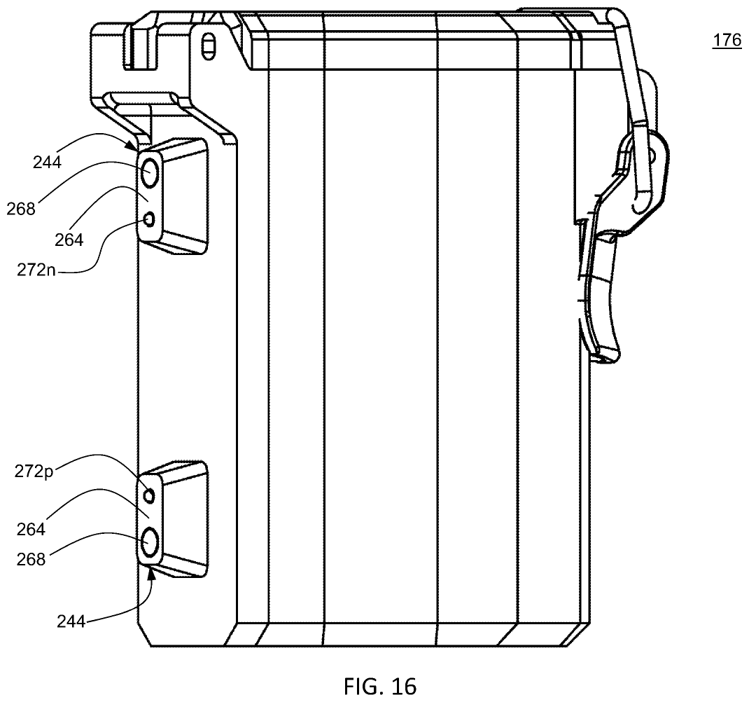

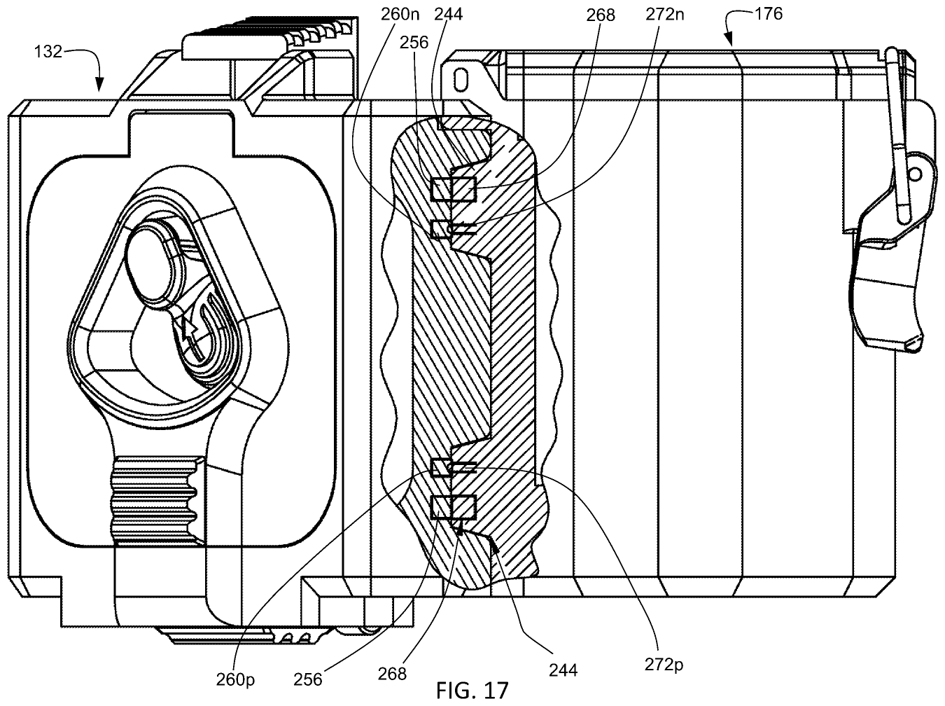

Referring now to FIGS. 13-17, and with continued reference to FIGS. 1-12, there is illustrated the manner of attachment of the battery packs 176 to the battery pack center base module 132. The battery pack housing 184 includes a pair of frusto-pyramidical lugs 244 which releasably seat in correspondingly shaped receptacles or sockets 248 formed in the side surface 148 of the battery pack center base module 132. It will be recognized that the lugs 244 may have other geometrical configurations, such as frusto-conical, truncated triangular pyramid, and so forth. A base surface 252 of each receptacle 248 includes a magnetic fastener element 256 and an electrical contact 260p, 260n. An upper surface 264 of each lug 244 includes a magnetic fastener element 268 is aligned with the magnetic fastener element 256 and an electrical contact 272p, 272n which is aligned with a respective one of the electrical contacts 260p, 260n. In embodiments, the electrical contact 272n is electrically coupled to the negative terminal of the battery(ies) 200 in the battery pack 176 and the electrical contact 272p is electrically coupled to the positive terminal of the battery (ies) 200 in the battery pack 176.

In certain embodiments, the magnetic fastener elements 256 and 268 are each permanent magnets wherein the aligned faces are of opposite polarity to provide a physical connection between the battery pack center base module 132 and the battery pack 176 when the lugs 244 are inserted into the sockets 248. In alternative embodiments, for each of the magnetic fastener element pairs 256, 268, one is a permanent magnet and the other is formed of a magnetically attractable material such as a ferromagnetic metal to provide a physical connection between the battery pack center base module 132 and the battery pack 176. In operation, to remove the battery pack 176 from the battery pack center base module 132 the user exerts a pulling force on the battery pack 176 which is greater than the magnetic force of attraction between the fastener elements 256, 268.

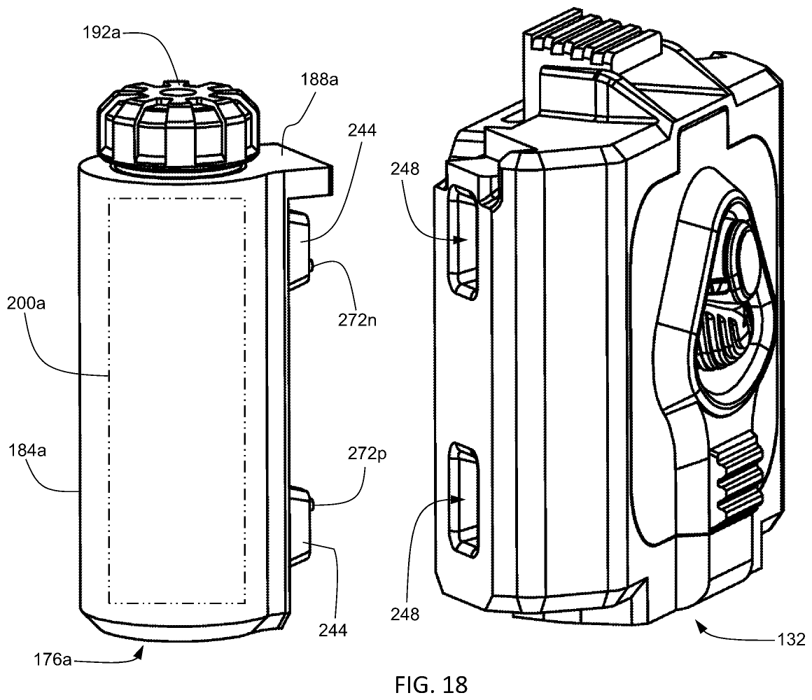

Referring now to FIG. 18, and with continued reference to FIGS. 1-17, there appears the battery pack center base module 132 and a first alternative embodiment battery pack 176a. In the illustrated exemplary embodiment, the battery pack 176a includes a housing 184a defining a battery compartment configured to receive a single AAA battery 200a. The housing 184a has an open upper end 188a which is closed by a removable threaded cap 192a.

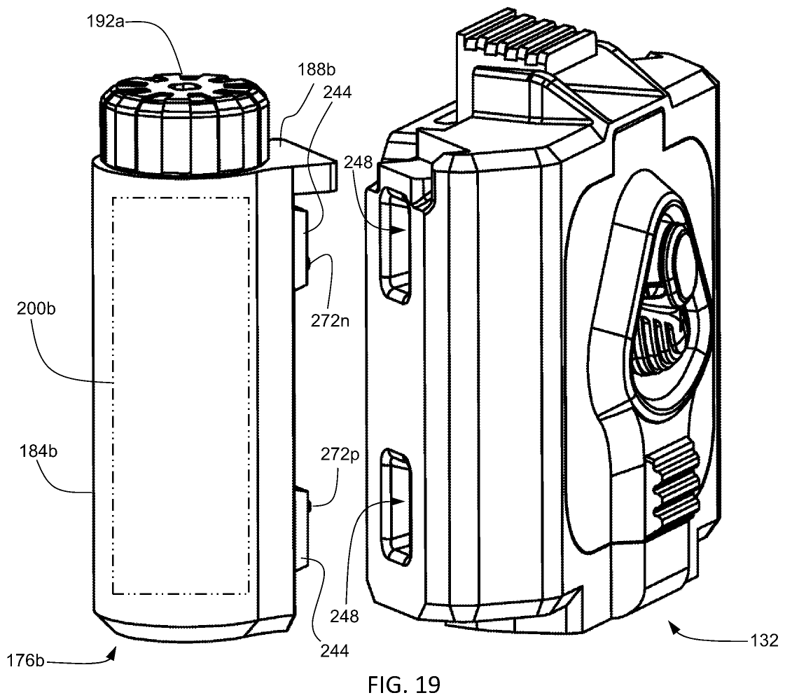

Referring now to FIG. 19, and with continued reference to FIGS. 1-18, there appears the battery pack center base module 132 and a second alternative embodiment battery pack 176b. In the illustrated exemplary embodiment, the battery pack 176b includes a housing 184b defining a battery compartment configured to receive a single CR123A battery 200b. The housing 184b has an open upper end 188b which is closed by a removable threaded cap 192a.

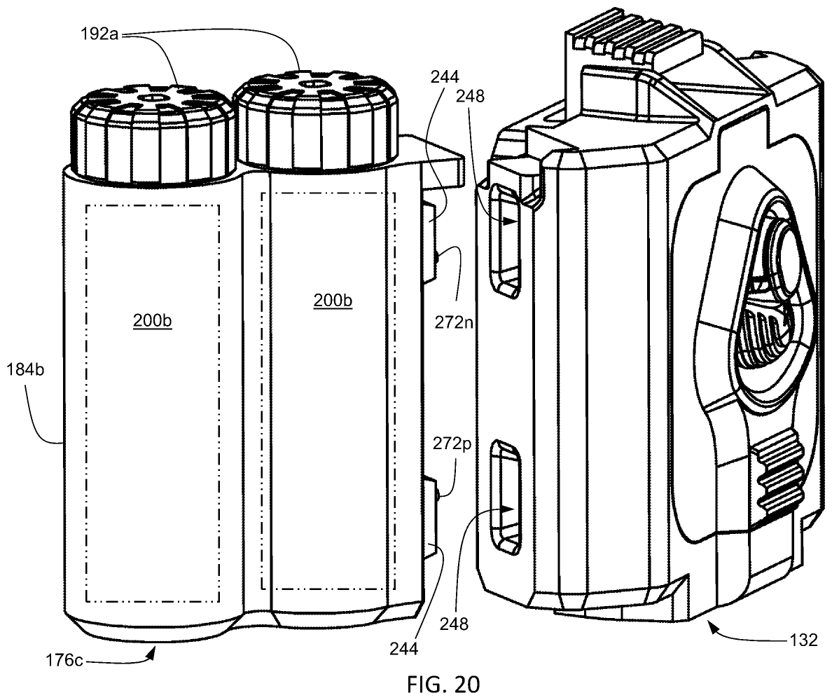

Referring now to FIG. 20, and with continued reference to FIGS. 1-19, there appears the battery pack center base module 132 and a third alternative embodiment battery pack 176c. In the illustrated exemplary embodiment, the battery pack 176c includes a housing 184c defining two battery compartments each configured to receive a CR123A battery 200b. The battery compartments have an open upper ends which are closed by removable threaded caps 192a.

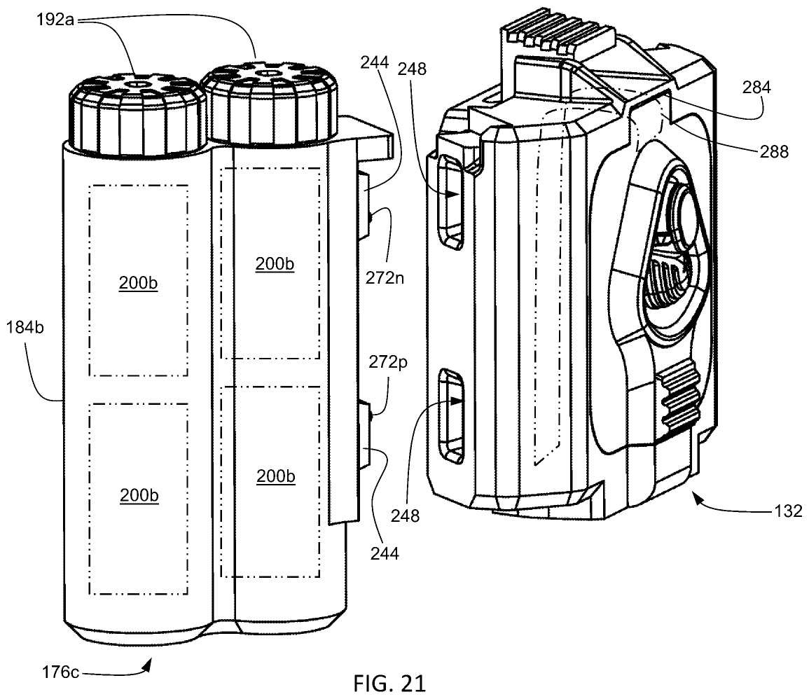

Referring now to FIG. 21, and with continued reference to FIGS. 1-20, there appears the battery pack center base module 132 and a fourth alternative embodiment battery pack 176d. In the illustrated exemplary embodiment, the battery pack 176d includes a housing 184d defining two battery compartments each configured to receive two CR123A batteries 200b. The battery compartments have an open upper ends which are closed by removable threaded caps 192a.

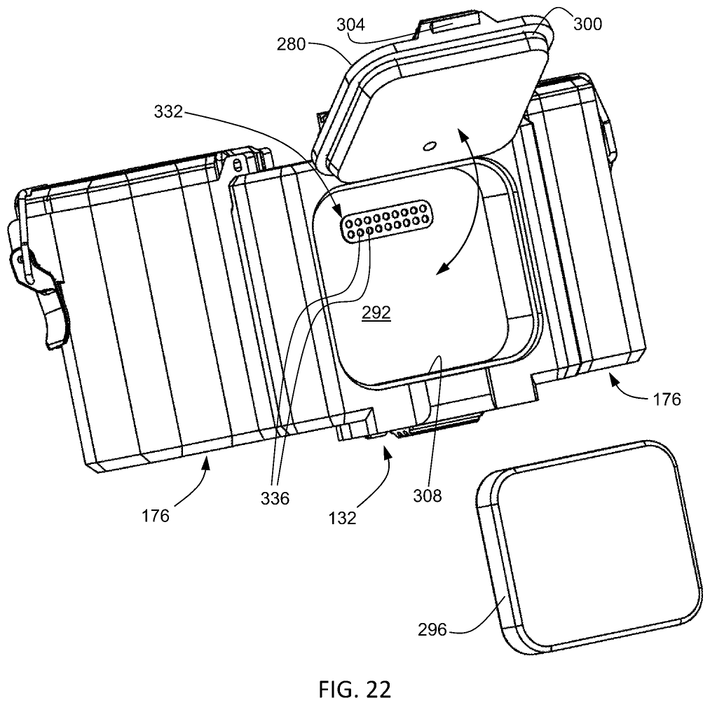

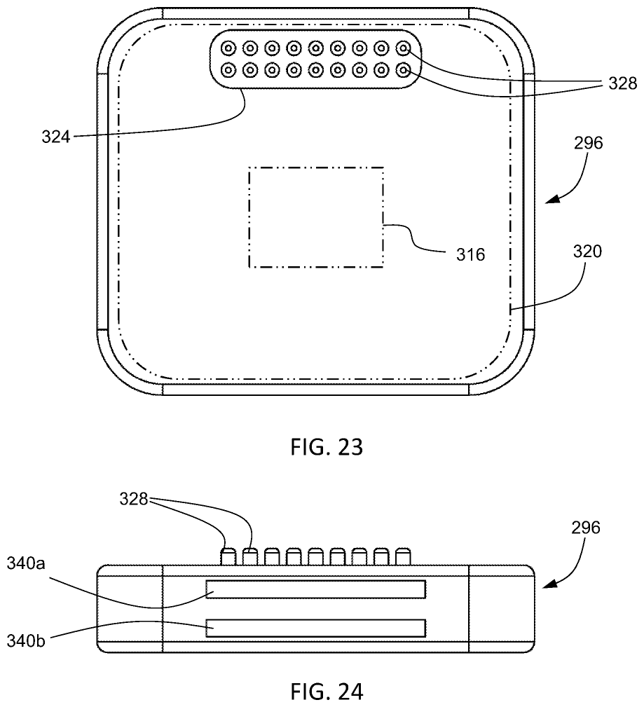

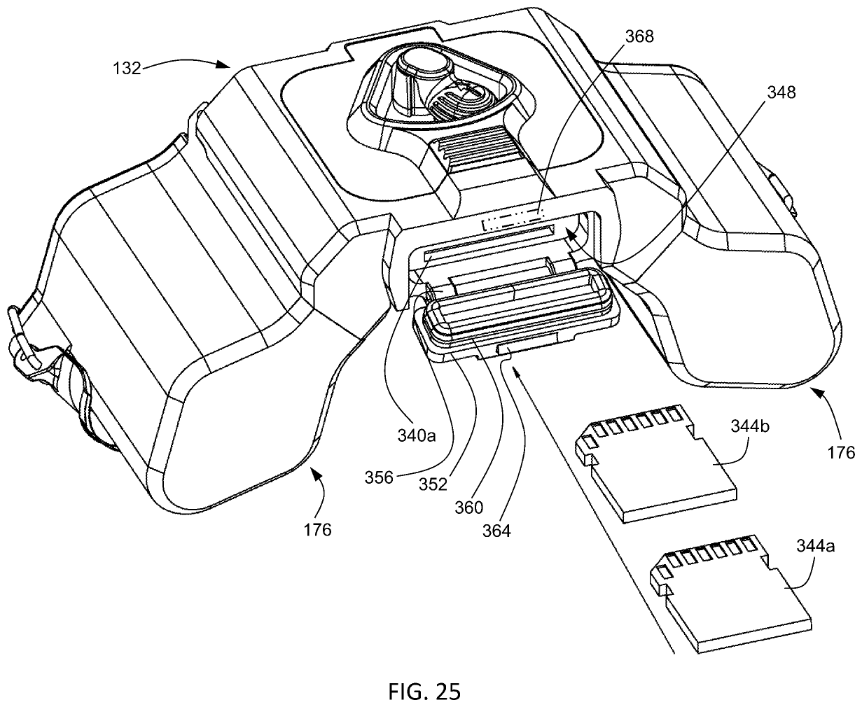

Referring now to FIGS. 22-25, and with continued reference to FIGS. 1-21, the battery pack center base module 132 includes a hatch door 280 on the rear surface 156 of the main body 136 which covers a cavity 292 configured to receive a modular processing board cartridge 296. The door 280 is pivotable about a hinge 284. The battery pack selector switch 172 is electrically coupled to the electrical components within the main body 136 via a flex circuit 288 which passes through the hinge 284 and which includes circuit conductors or traces formed on a flexible substrate such as a flexible tape or film material, which may be formed, e.g., of a polymeric material. An elastomeric O-ring or gasket 300 is provided to seal against entry or moisture or other contamination into the cavity 292. The door 280 is retained in the closed position via a latch member 304 releasably engaging a catch 308 on the main body 136 housing. The door 280 is opened by manually disengaging the latch member 304 from the catch using a latch release 312 disposed on the door 280.

The modular processing board cartridge 296 includes a main board 316 including a processor 320, such as microprocessor, central processing unit, microcontroller, or the like, including an associated memory and processing electronics. A connector interface 324 includes a plurality of electrical contacts 328 which engage aligned electrical contacts 336 on a mating connector 332 disposed in the cavity 292. In embodiments, the contacts 328 are spring loaded pogo pins of the type comprising a barrel, plunger and encapsulated spring and the contacts 336 are complementary contact pads. The modular processing board cartridge 296 allows the processing capability of the battery pack center base module 132 to be swapped and updated. In certain embodiments, the cartridge dimensions and pin locations are controlled with an interface control document (ICD) to provide an open architecture allowing other manufacturers to make their own customized processing units tailored for specific electrical and processing requirements. In such embodiments, the center base module 132 is an “open architecture” platform allowing other manufactures to install their own unique electronic circuity in the cavity 292.

The modular processing board cartridge 296 includes first and second card slots 340a and 340b for receiving first and second nonvolatile memory cards 344a and 344b, respectively, such as flash memory cards, Secure Digital (SD) cards, or the like. The modular processing board cartridge 296 is inserted and removed via the hatch door 280. In certain embodiments, one of the card slots 340a, 340b is used for expandable storage, to upload mission profiles, and/or for software/firmware upgrades, and the other one of the card slots 340a, 340b is used for programming logic and the operating system.

The first and second nonvolatile memory cards 344a and 344b are inserted and removed from the first and second card slots 340a and 340b through an opening 348 in the bottom surface 144 of the battery pack center base module 132. The opening 348 is covered by a bottom door 352 which is attached to the main body 136 via a hinge 356. An elastomeric O-ring or gasket 360 provides a scaling interference between the door 352 and the main body 136 to prevent entry of moisture or other contamination into the cavity 292 or cartridge 296. A releasable latch 364 on the bottom door 352 engages a catch 368 on the main body 136.

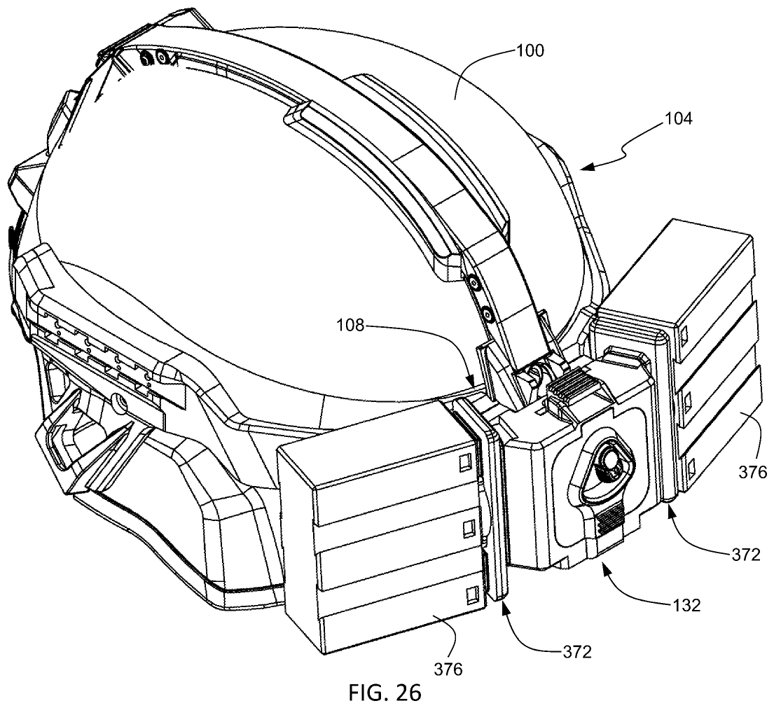

Referring now to FIG. 26 and with continued reference to FIGS. 1-25, there is shown a helmet 100 with helmet mount assembly 104 with the rear battery mounting bracket 108 receiving the battery pack center base module 132, as shown in FIG. 1, wherein the battery pack center base module 132 has left and right Small Tactical Universal Battery (STUB) battery packs 376 attached to each of the left and right side surfaces 148 of the battery pack center base module 132 via STUB adapters 372.

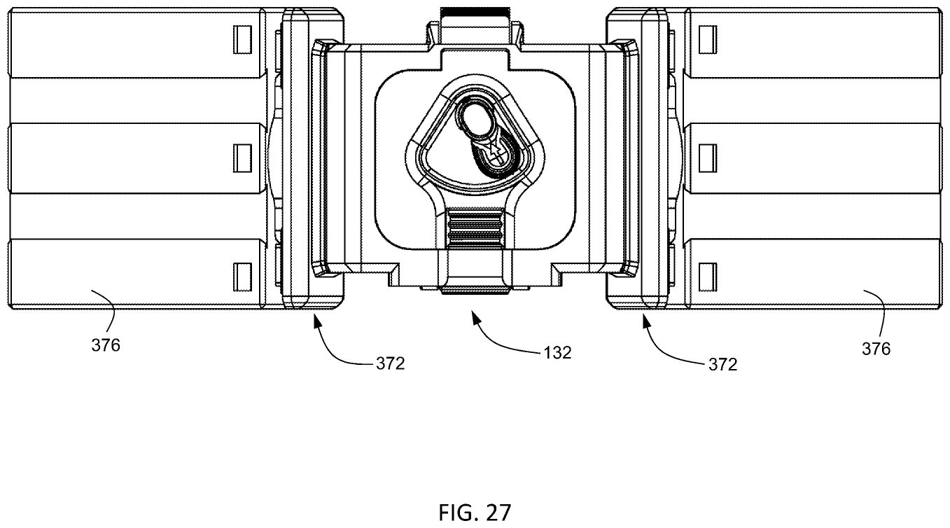

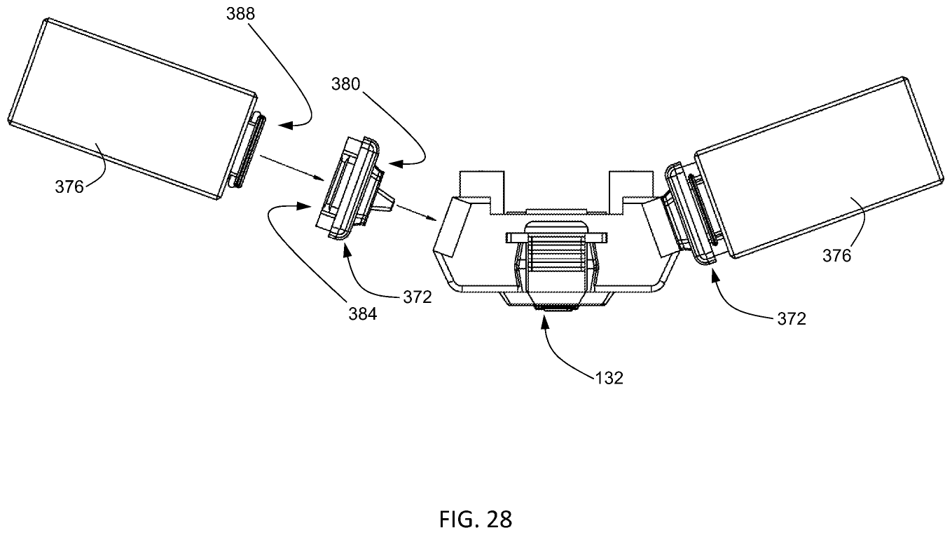

Referring now to FIGS. 27 and 28, and with continued reference to FIGS. 1-26, each STUB adapter 372 has a first interface surface 380 configured to detachably engage with the side surfaces 148 on the battery pack center base module 132 and a second interface surface 384 opposite the first interface surface 380 configured to detachably engage with a standard STUB battery pack interface 388.

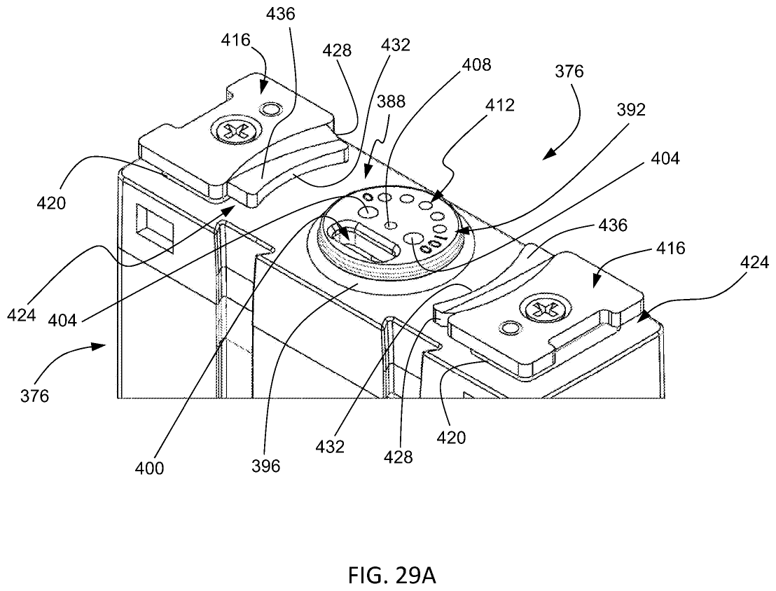

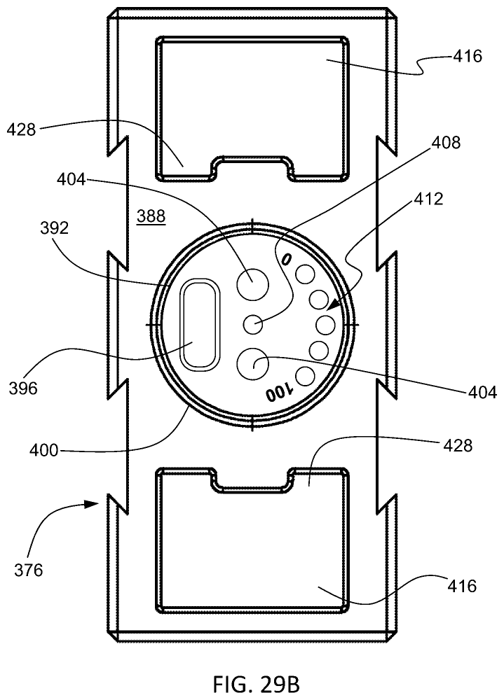

Referring now to FIGS. 29A and 29B, and with continued reference to FIGS. 1-28, there is shown an exemplary STUB battery pack 376 which includes an interface surface 388. In the illustrated embodiment, the STUB interface surface 388 includes a center terminal 392. The center terminal includes an elastomeric sealing ring 396 for sealing between the terminal 392 and the housing of the battery pack 376. The terminal 392 includes a USB-C charging port 400, power terminals 404 404, a control signal terminal 408, and state of charge indicia 412. In certain embodiments, the STUB battery pack 376 may be generally as described in U.S. Patent Application Publication No. 2022/0216554 published on Jul. 7, 2022, which is incorporated herein by reference in its entirety.

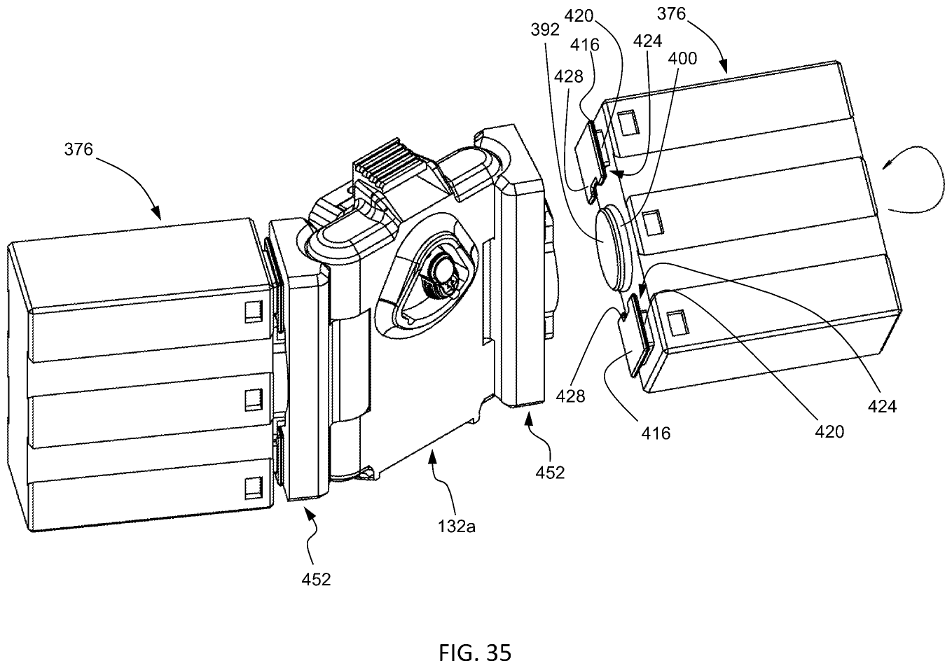

Tabs 416 are disposed at opposing ends of the interface surface 388 and are supported on respective posts or bosses 420 (see FIG. 35) to define a peripheral retention channel 424 between the tabs and the interface surface 388. The tabs 416 include bayonet or twist type retention elements 428 for attachment of the battery pack 376 to the adapter surface 384 via twisting movement of the battery pack 376 relative to the stub adapter second interface surface 384.

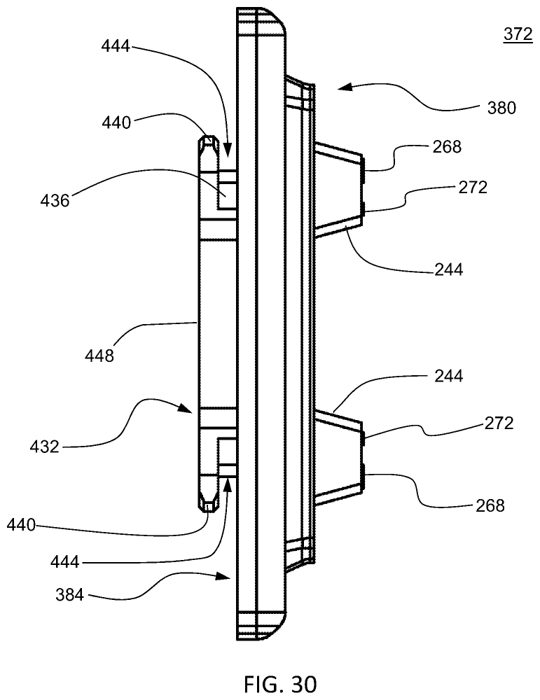

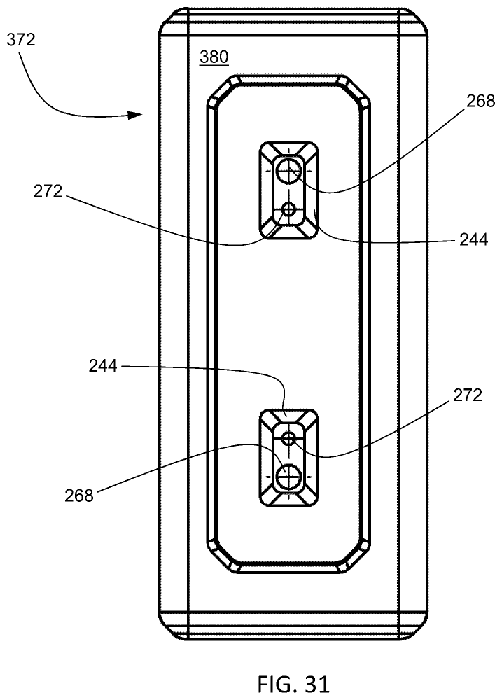

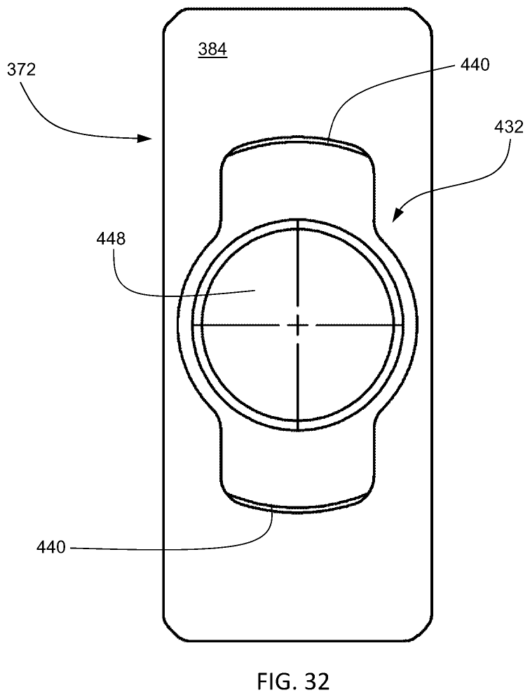

Referring now to FIGS. 30-32, and with continued reference to FIGS. 1-29B, the adapter first interface surface 380 includes a pair of connector lugs 244 as described above each having a magnet fastener element 268 and an electrical connector element 272. The adapter 372 is physically attached and detached from the side surfaces 148 of the battery pack center base module 132 via the magnetic fastener elements as described above.

The second adapter interface surface 384 includes a bayonet type mount 432 including a center post 436 and opposing cars 440. The cars 440 extend from the post 436 to define a retention groove 444 between each of the cars 440 and the surface 384. A center terminal 448 on the bayonet mount assembly 432 is aligned with the center terminal 392, which includes terminals that are electrically coupled to the terminals 272 on the first interface surface 380 to electrically couple the battery pack 376 to the battery pack center base module 132.

In operation, to attach the battery pack 376 to the adapter second interface surface 384, the battery pack 376 is positioned so that the center terminals 392 and 448 are aligned and the twist retention elements 428 on the STUB battery pack 376 are angularly offset with respect to the bayonet cars 440 on the adapter second interface 384. The STUB battery pack 376 is then rotated to cause the twist retention elements 428 to engage the retention grooves 444. To remove the battery pack 376 from the adapter second interface surface 384, the process is reversed.

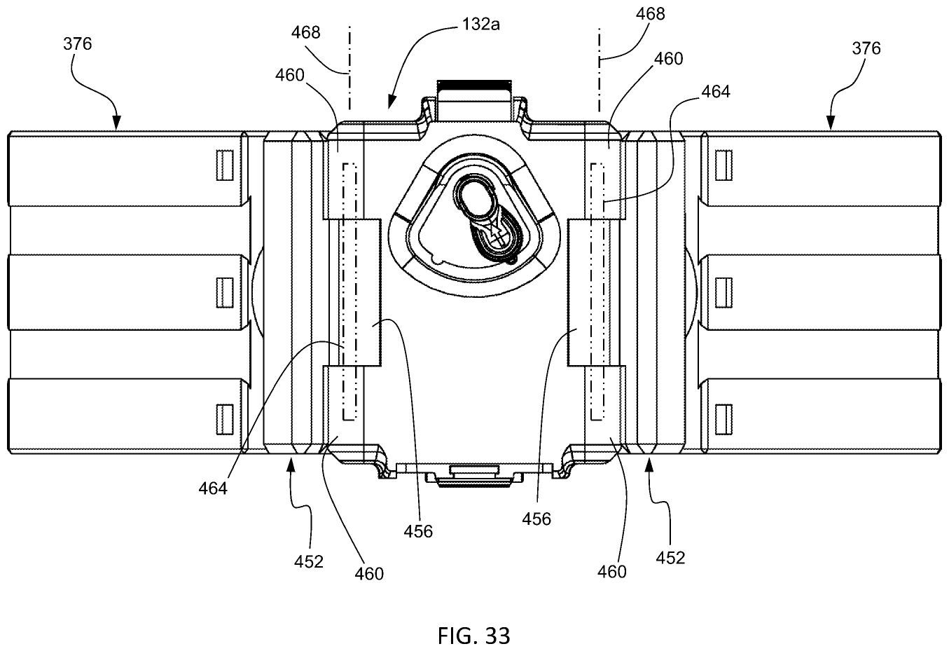

Referring now to FIGS. 33-35 and with continued reference to FIGS. 1-32, there is shown a second embodiment battery pack center base module 132a, which is as described above by way of reference to the battery pack center base module 132, except that the left and right side surfaces 148 have been replaced with hinged STUB attachment interface assemblies 452.

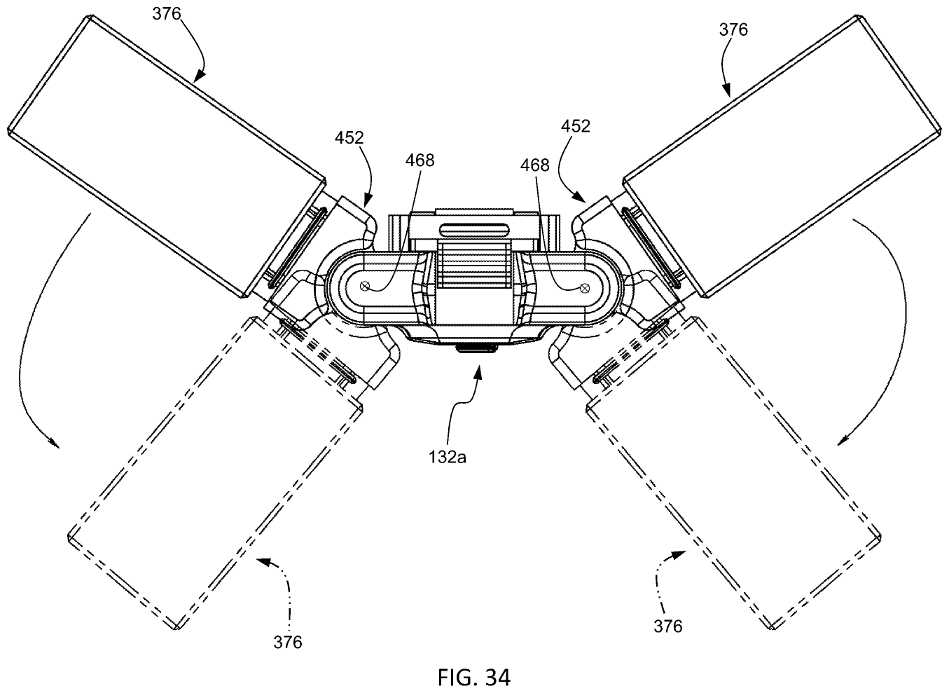

In certain embodiments, the hinge interface assemblies 452 each include a hinge knuckle 456 intermeshed between two hinge knuckles 460 on a main body 136a of the battery pack center base module 132a and rotatably attached with a hinge pin 464, each defining a pivot axis 468. As best seen in FIG. 34, the hinged connection allow the battery packs 376 to be pivoted about the axis 468 toward the helmet during normal use (as shown in solid lines in FIG. 34), and to be pivoted away from the helmet (as shown in broken lines in FIG. 34) when it is desired to remove or replace the battery pack 376.

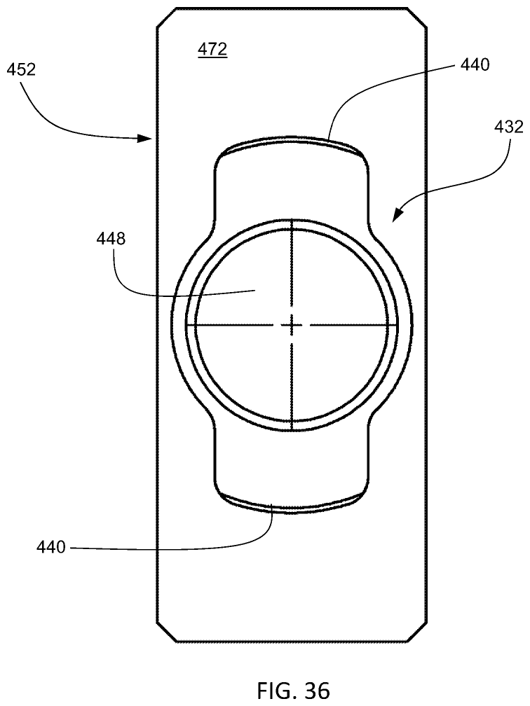

Referring now to FIG. 36, and with continued reference to FIGS. 1-35, there is shown an interface surface 472 of the hinge assembly 452 which is configured to detachably engage with the interface surface 388 (sec FIGS. 29A and 29B) of the STUB battery pack 376.

The interface surface 472 includes a bayonet type mount 432 including a center post 436 (see FIG. 30) and opposing cars 440. The cars 440 extend from the post 436 to define a retention groove 444 (sec FIG. 30) between each of the cars 440 and the surface 472. A center terminal 448 on the bayonet mount assembly 432 is aligned with the center terminal 392, which includes terminals that engage the terminals 404 to electrically couple the battery pack 376 to the battery pack center base module 132a.

In operation, to attach the battery pack 376 to STUB hinge interface 472, the battery pack 376 is positioned so that the center terminals 392 and 448 are aligned and the twist retention elements 428 on the STUB battery pack 376 are angularly offset with respect to the bayonet cars 440 on the hinge interface 472. The STUB battery pack 376 is then rotated to cause the twist retention elements 428 to engage the retention groove 444. To remove the battery pack 376 from the hinge interface 472, the hinged adapter 452 is pivoted so that the interface surface 472 faces away from the helmet and battery pack 376 is twisted until the twist retention elements 428 disengage from the retention grooves 444.

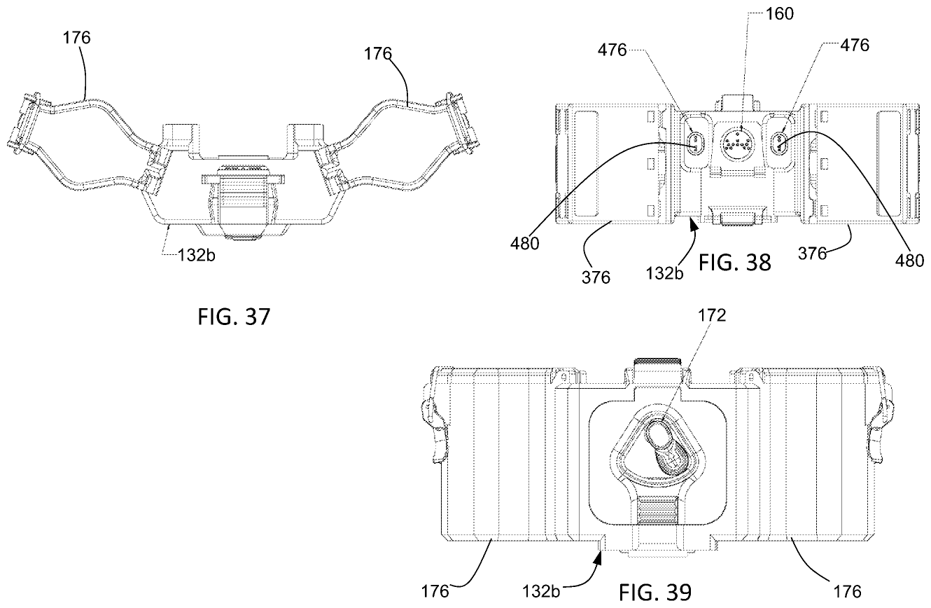

Referring now to FIGS. 37-39, there is shown a third embodiment battery pack center base module 132b with left and right battery packs. In FIGS. 37 and 39, the battery packs are battery packs 176. In FIG. 38, the battery packs are STUB battery packs 376. The battery pack center base module 132b includes left and right power and data connectors 476 having power and data contacts 480. The left and right power and data connectors 476 are disposed on opposite sides of the hot shoe receptacle 160. In embodiments, the battery pack center base module 132b may be in other respect as described above by way of reference to the battery pack center base module 132 except as other otherwise specified herein.

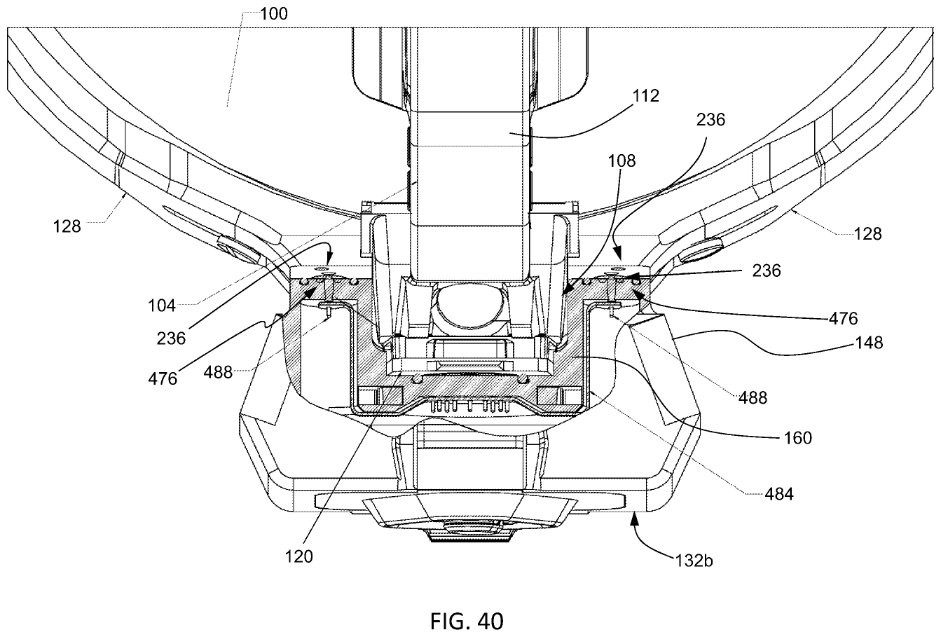

As best seen in FIG. 40, the connectors 480 on the battery pack center base module 132a connect to corresponding the left and right side shrouds or brackets 128 of the helmet mount assembly 104. A circuit board 484 is disposed within the housing of the battery pack center base module 132b which has left and right power and data contacts 488 thereby electronically and electrically bridging the bridging the left and right car brackets 128. The circuit board 484 is also operably coupled to the circuitry within the center strap/cable cover 112 via the hot shoe interface 120 Finally, the circuit board 484 is operably coupled to the control board or processing board 296 in the battery pack center base module 132b. In this manner the battery pack center base module 132b has connections to bridge or tie the right and left ear brackets 128 together as well as connect the control board in the battery box to the helmet mount assembly 104.

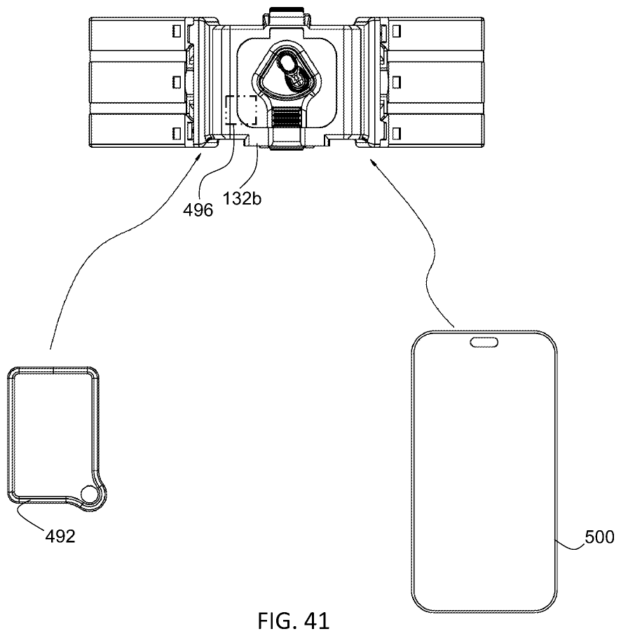

FIG. 41 illustrates two alternative methods of programming a modular processing board cartridge 296 within the battery pack center base module 132b, e.g., for a specific mission profile.

In a first programming method, the modular processing board cartridge 296 within the battery pack center base module 132b is programmed using an application on a mobile phone or other mobile device 500 which is paired with the battery pack center base module 132b via an RF communication protocol, such as Bluetooth.

In a second method, a wireless RFID (Radio Frequency Identification) token or tag 492 is provided, which uses radio waves to communicate with an RFID reader 496 within the battery pack center base module 132b. The token 492, which may be active or passive is advantageously used for changing the configuration of multiple battery pack center base modules for mass programming.

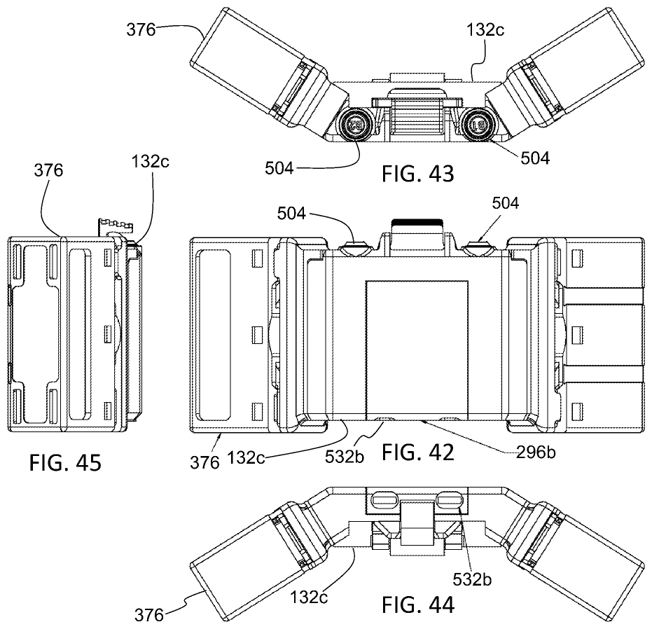

Referring now to FIGS. 42-46, there is shown a fourth embodiment battery pack center base module 132c, which is configured for use with an interface control document (ICD) controlled smart cartridge. The battery pack center base module 132c may be generally as described above by way of reference to the battery pack center base module 132, except that rather than the battery lever switch for selecting between the left and right battery packs, dedicated left and right push button battery selector switches 504 are provided. In operation, each battery source can be activated by pressing the respective button 504. The right and left side batteries each have button activation control, B1 and B2, respectively. By selecting B1, the device will use power from battery 1 and disconnect power from battery 2, and vice versa. In embodiments, the push button switches are operable to provide uninterrupted power when switching between batteries to prevent inadvertently power cycling an attached accessory device.

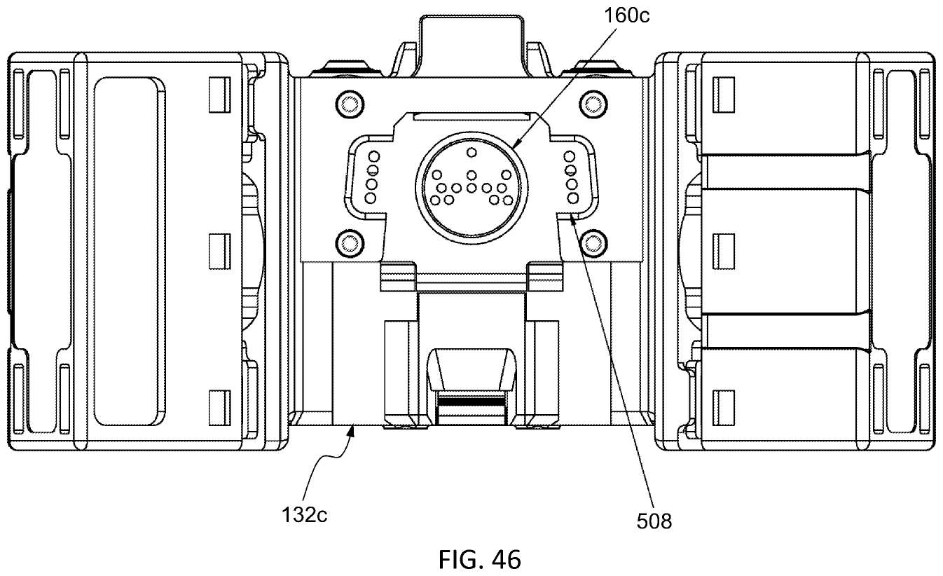

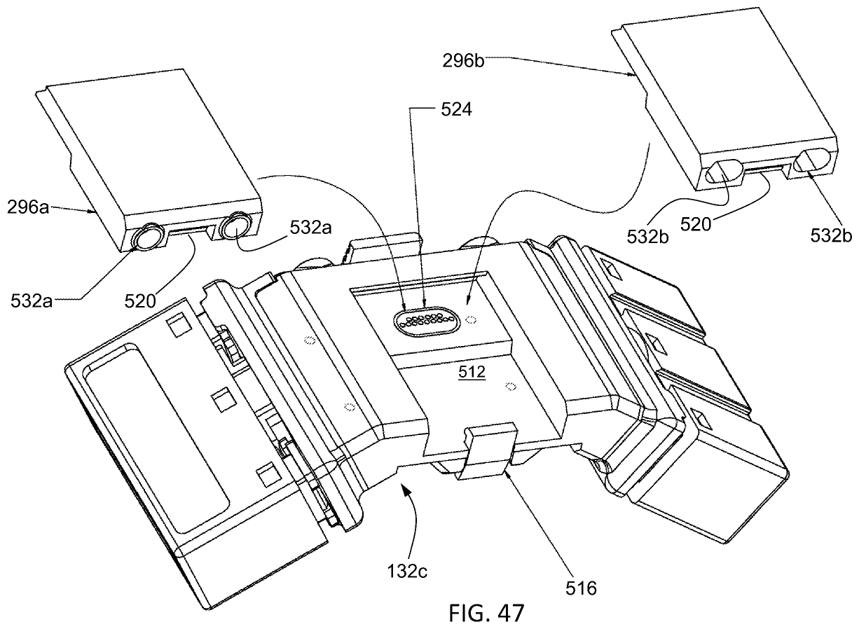

Referring now to FIG. 46, the battery pack center base module 132c has a modified hot shoe interface 160c which has additional hot shoe pins 508 to connect the helmet mount assembly 104 to the battery pack center base module 132c. This bridges power and data from the control cartridge 296a, 296b (see FIGS. 47-52, through the battery pack center base module 132c and helmet mount assembly 104 to the powered side rail interfaces 128, the identification friend or foe system (IFF) 124, as well as headset, flashlight, and other integrated systems. In embodiments, an Interface Control Document is provided to specify, e.g., the pin-out and electrical characteristics of each contact, their functions (power, data, ground, drain, control signals, etc.), voltage levels, signal types, and other relevant parameters.

Referring now to FIGS. 47-52, the battery pack center base module 132c includes a recess or receptacle 512 configured to interchangeably receive a plurality of cartridge styles 296a, 296b. A latch 516 engages a complementary catch 520 on the cartridge 296a, 296b to releasable retain the cartridge 296a, 296b within the receptacle 512. An electrical interface 524 within the receptacle 512 operably engages a mating electrical interface 528 on the cartridge 296a, 296b. As best seen in FIG. 50, the cartridge 296a, 296b housing has a stepped profile which is complementary with the profile of the receptacle 512. In interface connection preferably uses scaling elements to ingress of moisture, dust, or other external contamination.

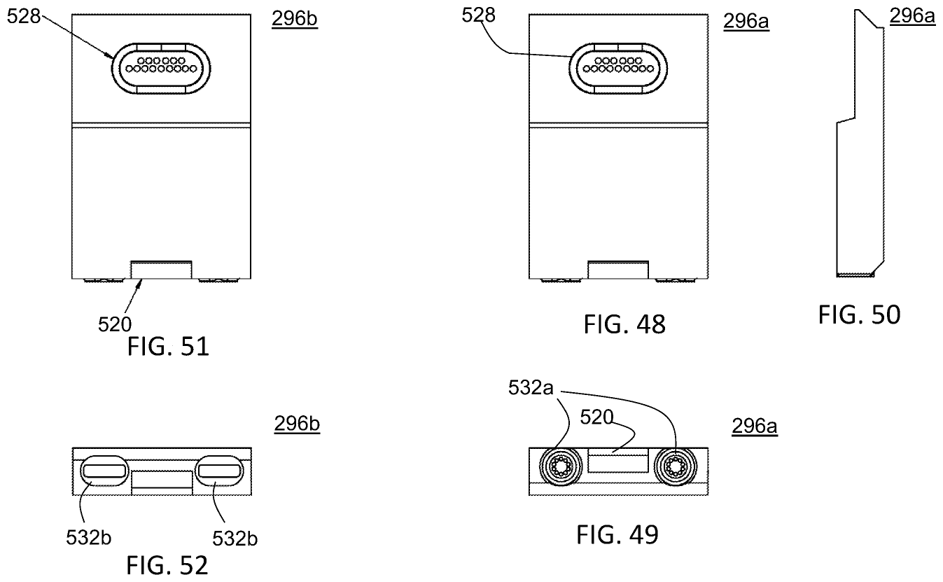

Referring now to FIGS. 48-50, there is shown a first cartridge style 296a, which includes Fischer connectors 532a. Fischer connectors are commercially available from Fischer Connectors SA (Saint-Prex, Switzerland). Referring now to FIGS. 51 and 52, there is shown a second cartridge style 296b, which includes USB Type-C connectors 532b. In embodiments, the connectors 532b are ruggedized U.S.C. § Type-C connectors. The connectors 532a, 532b provide a power, data, and/or control input and/or output interface to the battery pack center base module 132c and helmet mount assembly 104 powered side rail interfaces 128.

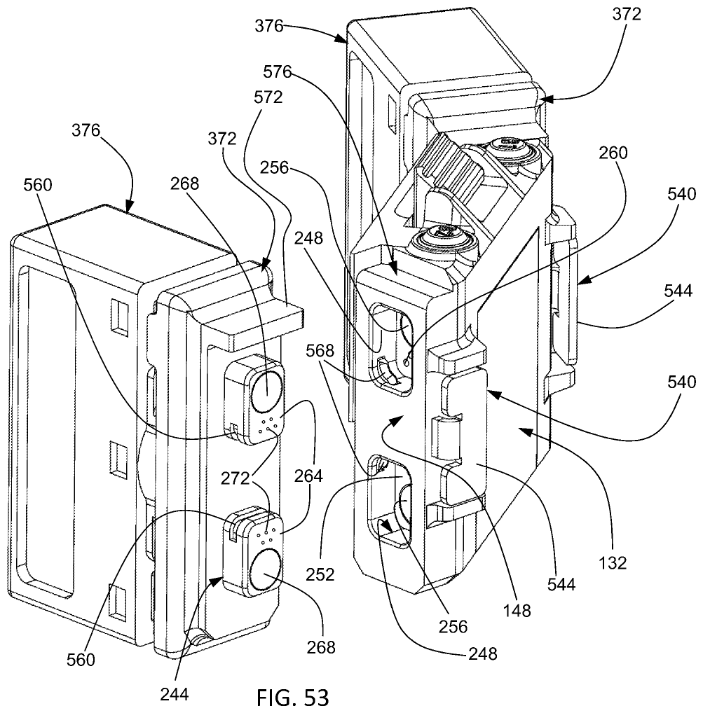

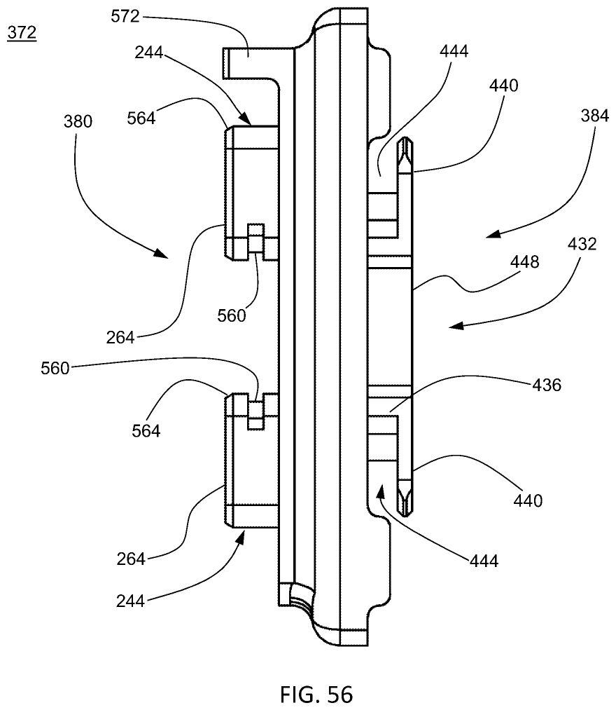

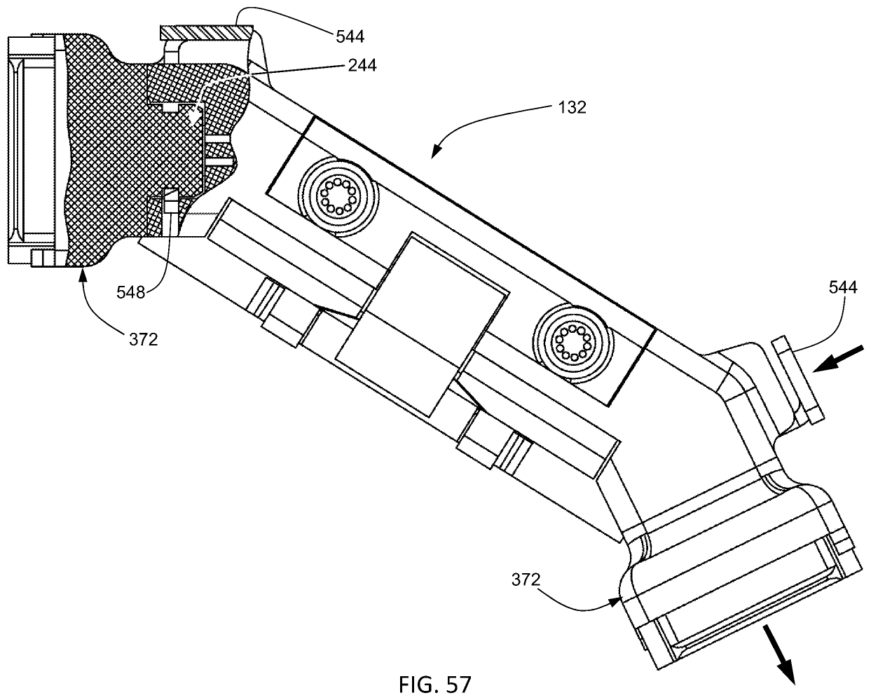

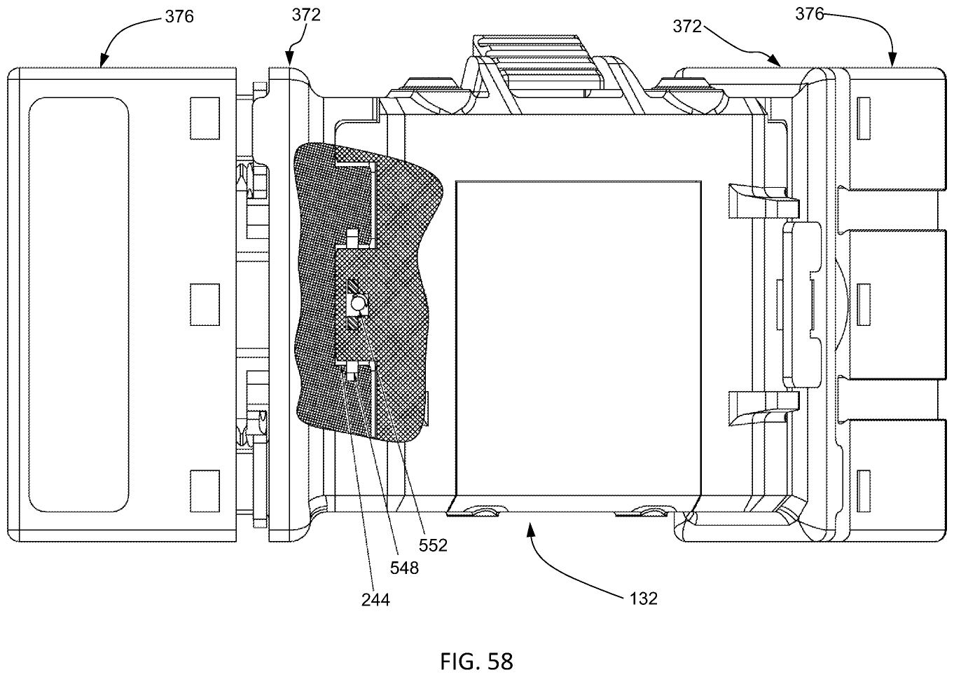

Referring now to FIGS. 53-58, there is shown an alternative embodiment battery pack center base module 132. The embodiment appearing in FIGS. 53-58 is particularly advantageous in various situations where the battery packs could become dislodged or jarred free from the center base module, such as a skydiver or paratrooper hitting the ground hard, an impact or collision experienced by the helmet, and so forth. The center base module 132 includes left and right side surfaces 148 having sockets 248. The battery pack center base module 132 has left and right STUB battery packs 376 attached to each of the left and right side surfaces 148 of the battery pack center base module 132 via STUB adapters 372.

Each STUB adapter 372 has a first interface surface 380 configured to detachably engage with the side surfaces 148 on the battery pack center base module 132 and a second interface surface 384 opposite the first interface surface 380 configured to detachably engage with a standard STUB battery pack interface 388.

The first interface surface 380 includes a pair of lugs 244 which releasably seat in correspondingly shaped receptacles or sockets 248 formed in the side surface 148 of the battery pack center base module 132. It will be recognized that the lugs 244 may have other geometrical configurations. A base surface 252 of each receptacle 248 includes a magnetic fastener element 256 and electrical contacts 260. An upper surface 264 of each lug 244 includes a magnetic fastener element 268 is aligned with the magnetic fastener element 256 and electrical contacts 272 which are aligned with respective ones of the electrical contacts 260.

The second interface surface 384 includes a bayonet type mount 432 including a center post 436 and opposing cars 440. The cars 440 extend from the post 436 to define a retention groove 444 between each of the cars 440 and the surface 384. A center terminal 448 on the bayonet mount assembly 432 is aligned with the center terminal 392 (see FIG. 29A) which includes terminals that are electrically coupled to terminals (not shown) as described above on the first interface surface 380 to electrically couple the battery pack 376 to the battery pack center base module 132.

In operation, to attach the battery pack 376 to the adapter second interface surface 384, the battery pack 376 is positioned so that the center terminals 392 and 448 are aligned and the twist retention elements 428 on the STUB battery pack 376 are angularly offset with respect to the bayonet cars 440 on the adapter second interface 384. The STUB battery pack 376 is then rotated to cause the twist retention elements 428 to engage the retention grooves 444. To remove the battery pack 376 from the adapter second interface surface 384, the process is reversed. In this manner the battery 376 can be attached and removed from the adapter 372 while leaving the adapter in place on the battery pack center base module 132.

In embodiments, the magnetic fastener elements 256 and 268 are each permanent magnets wherein the aligned faces are of opposite polarity to provide a physical connection between the battery pack center base module 132 and the battery pack 176 when the lugs 244 are inserted into the sockets 248. In alternative embodiments, for each of the magnetic fastener element pairs 256, 268, one is a permanent magnet and the other is formed of a magnetically attractable material such as a ferromagnetic metal to provide a physical connection between the battery pack center base module 132 and the battery pack 176.

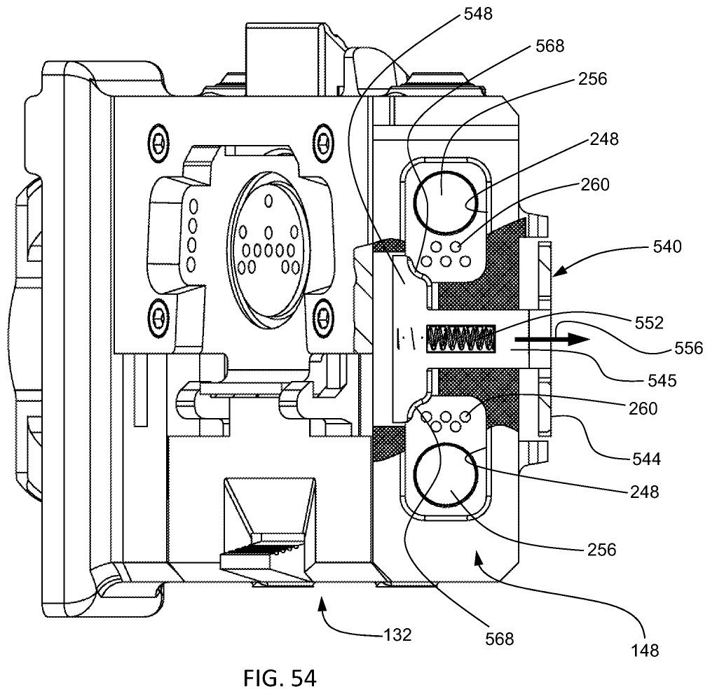

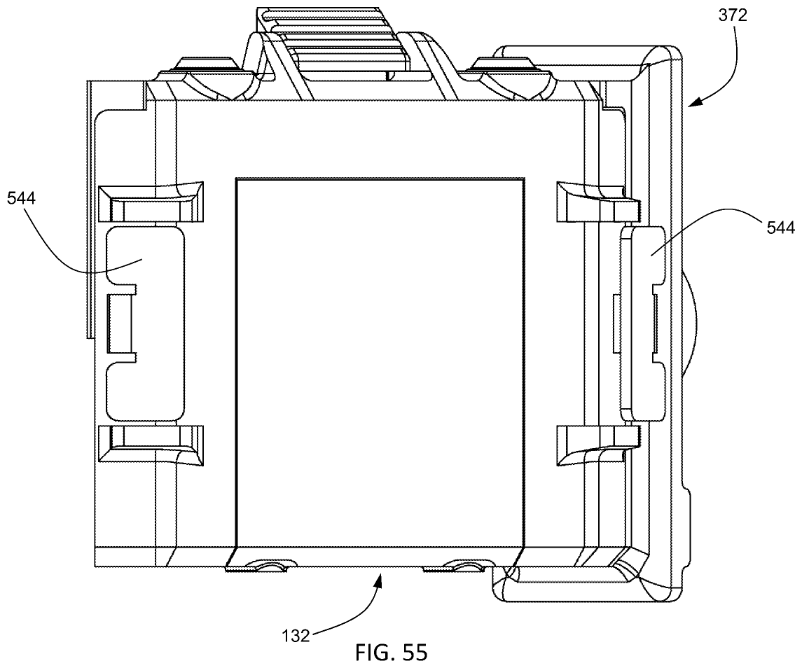

A locking bar assembly 540 includes a lock bar 545 received within the housing of the battery pack center base module 132. A first end of the lock bar 545 protrudes from the rearward surface of the housing of the battery pack center base module housing 132 and has a manually depressible tab 544. A second end of the lock bar 545 opposite the first end has a latching plate 548. The lock bar 545 is slidable within the housing in the fore and aft direction. A captured spring or like resilient member 552 has a first end bearing against an interior surface within the housing of the battery pack center base module 132. A second end of the captured spring or like resilient member 552 bears against lock bar 545 and urges the lock bar 545 into the locked position, i.e., in a rearward direction in relation to the battery pack center base module 132 as indicated by the arrow 556 in FIG. 54.

When the lock bar 545 is in the locked position, the latch plate 548 engages aligned grooves 560 in the lugs 244 and is retained therein by the spring force of the spring 552. When it is desired to detach the battery pack 376 and adapter module 372 from the battery pack center base module 132, the user manually depresses the lock bar tab 544 against the urging of the spring 552 until the latch plate 548 moved out of the grooves 560 and then exerts a pulling force on the battery pack 376 which is greater than the magnetic force of attraction between the fastener elements 256, 268. To attach the battery pack 376 and adapter module 372 from the battery pack center base module 132, the user aligns the lugs 244 with the sockets 248 and presses the lugs 244 into the sockets 248. The magnetic force of attraction aids the user in aligning the lugs 244 with the sockets 248, e.g., when the user is attaching the battery pack 376 and adapter module 372 while wearing the helmet.

When the adapter module 372 is being attached to battery pack center base module 132, ramped or beveled surfaces 564 on the lugs 244 slide past complementary ramped or beveled surfaces 568 on the latch plate 548. This provides a wedging action which causes the latch plate 548 to move out of the socket 248 against the urging of the spring 552 until the latch plate 548 is in axial alignment with the grooves 560 wherein the spring 552 causes the latch plate 548 to engage the grooves 560. In embodiments, a protrusion 572 on the adapter 372 aligns with a complementary notch 576 formed on the battery pack center base module 132 to provide a keyed configuration to ensure that an attached battery is in the proper orientation.

In operation, when the battery 376 is placed in proximity of the battery pack interface 372, the magnets 268 located in the battery pack adapter 372 and the magnets 256 in the sockets 248 of the battery interface 148 of the center module 132 attract each other, causing the battery 367 to home into its locking position. The battery locking plate 548 has a chamfered edge 568 on one side so that the force of the magnetic pull homing the battery creates a wedging action that moves the locking bar 544 out of the way overcoming the force of the battery locking bar spring 552. When the battery pack adapter is fully engaged into its locking position, the channel 560 geometry allows the locking plate 568 to slide back into the original locked position at the urging of the spring 552, creating a catch. To remove the battery, the user manually presses the tab portion 544 toward the center module housing while pulling on the battery 376 to overcome the attractive force of the magnets 256, 268.

The invention has been described with reference to the preferred embodiment. Modifications and alterations will occur to others upon a reading and understanding of the preceding detailed description. It is intended that the invention be construed as including all such modifications and alterations insofar as they come within the scope of the appended claims or the equivalents thereof.

What is claimed is:

1. A battery pack adapter, comprising:
a first side configured for coupling to a helmet accessory control unit; and
a second side opposite the first side configured for detachably coupling to a battery pack;
said first side comprising first and second protruding attachment lugs configured to be detachably received within first and second complementary receptacles, respectively, on the helmet accessory control unit;
each of the first and second protruding attachment lugs comprising a magnetic fastener element configured to magnetically engage with an aligned magnetic fastener element in a respective one of the complementary receptacles; and
each of the first and second protruding attachment lugs comprising electrical connector elements configured to establish an electrical connection with aligned electrical contacts in a respective one of the complementary receptacles.

2. The battery pack adapter of claim 1, wherein each of the first and second protruding attachment lugs comprise a slot configured to removably receive a locking plate when the battery pack adapter is attached to the helmet accessory control unit.

3. The battery pack adapter of claim 1, wherein the second side is configured for detachable coupling to a battery pack which conforms to a Small Tactical Universal Battery (STUB) standard for battery pack interfaces.

4. A battery pack system for a helmet mount assembly comprising at least one battery pack adapter of claim 1 and the helmet accessory control unit.

5. The battery pack system of claim 4, wherein the helmet mount assembly is a center base module configured for electrical and physical attachment to a helmet mount assembly, the battery pack system further comprising:
a first battery pack; and
the at least one battery pack adapter including a first battery pack adapter configured to be detachably coupled to a first side of the center base module wherein the first and second protruding lugs are configured for removable attachment to aligned and facing first and second sockets on the first side of the center base module.

6. The battery pack system of claim 5, further comprising:
a first lock bar on the center base module and movable between a locking position and an unlocking position, the first lock bar including a first latching plate engaging complementary grooves in the first and second protruding lugs on the first battery pack when the first adapter is attached to the center base module.

7. The battery pack system of claim 5, further comprising:
a second battery pack; and
the at least one battery pack adapter including a second battery pack adapter configured to be detachably coupled to a second side of the center base module wherein the first and second protruding lugs are configured for removable attachment to aligned and facing first and second sockets on the second side of the center base module.

8. The battery pack system of claim 7, further comprising:
a second lock bar on the center base module and movable between a locking position and an unlocking position, the second lock bar including a second latching plate engaging complementary grooves in the first and second protruding lugs on the second battery pack when the second adapter is attached to the center base module.

9. A battery pack system for a helmet mount assembly, comprising:
a center base module configured for electrical and physical attachment to a helmet mount assembly;
first and second battery packs for removable attachment to the center base module;
each of the first and second battery packs having a pair of protruding attachment lugs, each of the attachment lugs having first magnetic fastener element and a first electrical connector element;
the center base module having a first side surface configured for detachably securing the first battery pack;
the center base module having a second side surface opposite the first side surface configured for detachably securing the second battery pack;
each of the first and second side surfaces comprising a pair of lug receptacles for receiving a respective one of the pairs of protruding attachment lugs;
each lug receptacle having a second magnetic fastener element for physically coupling to a respective one of the first magnetic fastener elements; and
each lug receptacle having a second electrical connector element for electrically coupling to a respective one of the first electrical connector elements.

10. The battery pack system of claim 9, further comprising an adapter interchangeably attachable to the helmet mount assembly in place of the center base module and configured to releasably attach a third battery pack.

11. The battery pack system of claim 9, wherein the center base module comprises a modular processing system removably received within a main body of the center base module.

12. The battery pack system of claim 9, wherein the center base module comprises a switch configured to selectively couple a selected one of the first and second battery packs, wherein each of the first and second battery packs is replaceable independently of the other.

13. The battery pack system of claim 9, further comprising:
first and second adapters;
the first adapter having a first interface surface configured for removable attachment to the first side surface of the center base module and a second interface surface configured for removable attachment to the first battery pack; and
the second adapter having a third interface surface configured for removable attachment to the second side surface of the center base module and a fourth interface surface configured for removable attachment to the second battery pack.

14. The battery pack system of claim 13, wherein the first and second battery packs are STUB battery packs.

15. A battery pack system for a helmet mount assembly, comprising:
a center base module configured for electrical and physical attachment to a helmet mount assembly;
first and second battery packs for removable attachment to the center base module;
a first adapter hingedly attached to a first side of the center base module and having a first interface surface configured for removable attachment to the first battery pack; and
a second adapter hingedly attached to a second side of the center base module and having a second interface surface configured for removable attachment to the second battery pack.

16. The battery pack system of claim 15, wherein the first and second adapters are pivotable between a deployed position wherein the first and second battery packs are pivoted toward the helmet and a non-deployed position wherein the first and second battery packs are pivoted away the helmet to facilitate attachment and removal of the first and second battery packs.

17. The battery pack system of claim 15, wherein the first and second battery packs are STUB battery packs.
